(19) United States
(12) Patent Application Publication
(10) Pub. No.: US 2026/0082256 A1
(43) Pub. Date: Mar. 19, 2026

(54) CONCURRENT OR OVERLAPPING MEASUREMENT GAPS FOR LAYER ONE AND LAYER THREE MEASUREMENTS

(71) Applicant: QUALCOMM Incorporated, San Diego, CA (US)

(72) Inventors: Fang YUAN, Beijing (CN); Yan ZHOU, San Diego, CA (US); Changhwan PARK, San Diego, CA (US); Tao LUO, San Diego, CA (US)

(21) Appl. No.: 19/109,091

(22) PCT Filed: Oct. 31, 2023
(86) PCT No.: PCT/CN2023/128267

§ 371 Date: Mar. 5, 2025

(30) Foreign Application Priority Data
Nov. 1, 2022 (WO) PCT/CN2022/128876
Nov. 1, 2022 (WO) PCT/CN2022/128899

(51) Int. Cl. H04W 24/10; H04W 8/24; H04W 24/08

(52) U.S. Cl. CPC H04W 24/10; H04W 8/24; H04W 24/08

(57) ABSTRACT

Methods, systems, and devices for wireless communication are described. To switch between candidate serving cells, a user equipment (UE) may perform layer one (L1) or layer three (L3) channel measurements associated with the serving cells. If the serving cells operate in different frequencies, the UE may perform the channel measurements in concurrent measurement gaps. The UE may select a measurement gap for the channel measurements based on a scheduling conflict between multiple measurement gaps. Alternatively, a UE may receive signals identifying a set of channel measurements and indicating at least a measurement gap associated with each of an L1 measurement and a second L1 and/or an L3 measurement. The UE may select a measurement according to a prioritization between the measurement gaps and an overlap in time between the measurement gaps. The UE may perform the set of channel measurements based on the first or second measurement gap.

### CROSS REFERENCE

The present Application is a 371 national stage filing of International PCT Application No. PCT/CN2023/128267 by YUAN et al. entitled “CONCURRENT OR OVERLAPPING MEASUREMENT GAPS FOR LAYER ONE AND LAYER THREE MEASUREMENTS,” filed Oct. 31, 2023; and claims the benefit of International Application PCT/CN2022/128899 by YUAN et al., entitled “CONCURRENT MEASUREMENT GAPS FOR LAYER ONE INTER-FREQUENCY MEASUREMENTS,” filed Nov. 1, 2022, assigned to the assignee hereof, and expressly incorporated by reference herein. The present Application for Patent also claims the benefit of International Application PCT/CN2022/128876 by YUAN et al., entitled “OVERLAPPING MEASUREMENT GAPS IN LAYER ONE AND LAYER THREE MEASUREMENTS,” filed Nov. 1, 2022, each of which is assigned to the assignee hereof, and each of which is expressly incorporated by reference in its entirety herein.

### TECHNICAL FIELD

The following relates to wireless communication, including concurrent or overlapping measurement gaps for layer one (L1) or layer three (L3) measurements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may perform mobility and handover procedures to switch between candidate serving cells. In some cases, however, techniques for performing channel measurements for the candidate serving cells may be improved.

### SUMMARY

The described techniques relate to improved methods, systems, devices, and UEs that support concurrent measurement gaps for layer one (L1) inter-frequency measurement. For example, the described techniques provide for defining and reporting a capability of supporting concurrent measurement gaps for L1 channel measurements. In some examples, a user equipment (UE) may transmit a capability message indicating its support of concurrent measurement gaps for channel measurements. In some cases, the capability message may include one or more information elements indicating the support of such measurement gaps for L1 channel measurements, layer three (L3) channel measurements, or both. The UE may receive one or more signals indicating one or more measurement gaps associated with respective channel measurements (e.g., L1, layer two (L2), or L3 measurements). The UE may select at least one of the measurement gaps to use for performing L1 channel measurements based on a scheduling collision between the one or more signaled measurement gaps. That is, if two measurement gaps are at least partially overlapping in time, or if a distance in time between the two measurement gaps is less than a defined threshold, the concurrent measurement gaps may have a scheduling conflict that the UE may consider when selecting one or more of the measurement gaps to use. The UE may perform an L1 channel measurement, an L3 channel measurement, or both, using one or more of the selected measurement gaps, and the UE may transmit a channel measurement report in accordance with the measurement.

Additionally, or alternatively, the described techniques relate to improved methods, systems, devices, and UEs that support overlapping measurement gaps in L1 and L3 measurements. For example, the described techniques provide for configuring a UE to perform a set of measurements. For example, one or more signals (e.g., radio resource control (RRC) signaling, or downlink control information (DCI) signaling) may be used to configure or otherwise identify a set of measurements for the UE to perform. The set of measurements may include at least one L1 measurement (e.g., a first L1 measurement) and either another L1 measurement (e.g., a second L1 measurement) or a L3 measurement. Each configured measurement may be associated with a measurement gap, which generally defines when and where (e.g., in the time domain and frequency domain) the UE will monitor for the signal(s) (e.g., such as synchronization signal block (SSB), channel state information-reference signal (CSI-RS), or other reference and/or synchronization signals) to be measured. In some examples, a first measurement gap associated with the first L1 measurement and a second measurement gap associated with the second L1 measurement or L3 measurement may at least partially overlap in the time domain. Accordingly, aspects of the techniques described herein provide for a prioritization between the overlapping measurement gaps when the set of measurements includes a first L1 measurement and a second L1 or an L3 measurement. Broadly, the prioritization may be based on the gap priority of each measurement gap, the periodicity of each measurement gap, a layer-based prioritization (e.g., L3>L1, or vice versa). Accordingly, the UE may perform at least a portion of the set of measurement based on the first measurement gap or the second measurement gap according to the selected measurement gap.

A method for wireless communication by a UE is described. The method may include transmitting a capability message indicating a capability of the UE to support concurrent measurement gaps for L1 channel measurements, receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements, performing at least a portion of the set of channel measurements using the first measurement gap or the second measurement gap in accordance with the capability message, and transmitting a channel measurement report in accordance with performing at least the portion of the set of channel measurements.

A UE is described. The UE may include one or more memories storing processor-executable code and one or more processors coupled (e.g., operatively, communicatively, functionally, electronically, or electrically) with the one or more memories. The one or more processors may be individually or collectively operable to execute the code to cause the UE to transmit a capability message indicating a capability of the UE to support concurrent measurement gaps for L1 channel measurements, receive one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements, perform at least a portion of the set of channel measurements using the first measurement gap or the second measurement gap in accordance with the capability message, and transmit a channel measurement report in accordance with performing at least the portion of the set of channel measurements.

Another UE is described. The UE may include means for transmitting a capability message indicating a capability of the UE to support concurrent measurement gaps for L1 channel measurements, means for receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements, means for performing at least a portion of the set of channel measurements using the first measurement gap or the second measurement gap in accordance with the capability message, and means for transmitting a channel measurement report in accordance with performing at least the portion of the set of channel measurements.

A non-transitory computer-readable medium storing code for wireless communication at a UE is described. The code may include instructions executable by one or more processors (e.g., directly, indirectly, after pre-processing, without pre-processing) to transmit a capability message indicating a capability of the UE to support concurrent measurement gaps for L1 channel measurements, receive one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements, perform at least a portion of the set of channel measurements using the first measurement gap or the second measurement gap in accordance with the capability message, and transmit a channel measurement report in accordance with performing at least the portion of the set of channel measurements.

In some examples of the method, UEs, and non-transitory computer-readable medium described herein, transmitting the capability message may include operations, features, means, or instructions for transmitting, via the capability message, a single UE capability information element indicating that the UE may be capable of supporting the concurrent measurement gaps for both the L1 channel measurements and L3 channel measurements.

In some examples of the method, UEs, and non-transitory computer-readable medium described herein, transmitting the capability message may include operations, features, means, or instructions for transmitting, via the capability message, a first UE capability information element indicating that the UE may be capable of supporting the concurrent measurement gaps for the L1 channel measurements, where the first UE capability information element may be separate from a second UE capability information element indicating whether the UE may be capable of supporting the concurrent measurement gaps for L3 channel measurements.

Some examples of the method, UEs, and non-transitory computer-readable medium described herein may further include operations, features, means, or instructions for selecting one of the first measurement gap or the second measurement gap to apply for at least the portion of the set of channel measurements at the UE according to a scheduling collision between a first measurement gap occasion associated with the first measurement gap and a second measurement gap occasion associated with the second measurement gap.

Some examples of the method, UEs, and non-transitory computer-readable medium described herein may further include operations, features, means, or instructions for detecting the scheduling collision based on an overlap in time between the first measurement gap occasion and the second measurement gap occasion.

Some examples of the method, UEs, and non-transitory computer-readable medium described herein may further include operations, features, means, or instructions for detecting the scheduling collision based on a timing between the first measurement gap occasion and the second measurement gap occasion in time being equal to or less than a defined threshold.

In some examples of the method, UEs, and non-transitory computer-readable medium described herein, the timing between the first measurement gap occasion and the second measurement gap occasion may be measured between an end of the first measurement gap occasion and a beginning of the second measurement gap occasion, where the first measurement gap occasion occurs before the second measurement gap occasion in time.

In some examples of the method, UEs, and non-transitory computer-readable medium described herein, the defined threshold may be 4 milliseconds.

In some examples of the method, UEs, and non-transitory computer-readable medium described herein, the first measurement gap and the second measurement gap include inter-frequency measurement gaps.

In some examples of the method, UEs, and non-transitory computer-readable medium described herein, the first measurement gap may be associated with a first channel state information (CSI) report and the second measurement gap may be associated with a second CSI report.

A method for wireless communications at a UE is described. The method may include receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements, selecting one of the first measurement gap or the second measurement gap to apply for the set of channel measurements at the UE according to a prioritization between the first measurement gap and the second measurement gap and an overlap in time between the first measurement gap and the second measurement gap, and performing at least a portion of the set of channel measurements and using the first measurement gap or the second measurement gap according to the selecting.

A UE is described. The UE may include one or more memories storing processor-executable code, and one or more processors coupled (e.g., operatively, communicatively, functionally, electronically, or electrically) with the one or more memories. The one or more processors may be individually or collectively operable (e.g., directly, indirectly, after pre-processing, without pre-processing) to execute the code to cause the UE to receive one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements, select one of the first measurement gap or the second measurement gap to apply for the set of channel measurements at the UE according to a prioritization between the first measurement gap and the second measurement gap and an overlap in time between the first measurement gap and the second measurement gap, and perform at least a portion of the set of channel measurements based on the first measurement gap or the second measurement gap according to the selecting.

Another UE is described. The apparatus may include means for receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements, means for selecting one of the first measurement gap or the second measurement gap to apply for the set of channel measurements at the UE according to a prioritization between the first measurement gap and the second measurement gap and an overlap in time between the first measurement gap and the second measurement gap, and means for performing at least a portion of the set of channel measurements and using the first measurement gap or the second measurement gap according to the selecting.

A non-transitory computer-readable medium storing code for communications at a UE is described. The code may include instructions executable by one or more processors (e.g., directly, indirectly, after pre-processing, without pre-processing) to receive one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements, select one of the first measurement gap or the second measurement gap to apply for the set of channel measurements at the UE according to a prioritization between the first measurement gap and the second measurement gap and an overlap in time between the first measurement gap and the second measurement gap, and perform at least a portion of the set of channel measurements based on the first measurement gap or the second measurement gap according to the selecting.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first priority level associated with the first measurement gap and a second priority level associated with the second measurement gap.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first periodicity associated with the first measurement gap and a second periodicity associated with the second measurement gap.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first priority level associated with L1 measurements and a second priority level associated with L3 measurements.

In some examples of the method, UEs, and non-transitory computer-readable medium described herein, the second priority level includes a higher priority level than the first priority level.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first priority level associated with traffic to be communicated based on a result of the first L1 measurement and a second priority level associated with traffic to be communicated based on a result of the one or more of the second L1 measurement or the L3 measurement.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first priority level associated with a first CSI report to be communicated based on a result of the first L1 measurement and a second priority level associated with a second CSI report to be communicated based on a result of one or more of the second L1 measurement or the L3 measurement.

Some examples of the method, UEs, and non-transitory computer-readable medium described herein may further include operations, features, means, or instructions for determining a first identifier associated with the first CSI report and a second identifier associated with the second CSI report, where the first priority level may be based on the first identifier and the second priority level may be based on the second identifier.

In some examples of the method, UEs, and non-transitory computer-readable medium described herein, selecting the one of the first measurement gap or the second measurement gap may include operations, features, means, or instructions for prioritizing between the first measurement gap and the second measurement gap according to a difference between a first periodicity of a first CSI report to be communicated based on a result of the first L1 measurement and a second periodicity of a second CSI report to be communicated based on a result of one or more of the second L1 measurement or the L3 measurement.

Some examples of the method, UEs, and non-transitory computer-readable medium described herein may further include operations, features, means, or instructions for transmitting a channel measurement report in accordance with performing at least the portion of the set of channel measurements using the first measurement gap or the second measurement gap.

In some examples of the method, UEs, and non-transitory computer-readable medium described herein, the first measurement gap and the second measurement gap include inter-frequency measurement gaps.

In some examples of the method, UEs, and non-transitory computer-readable medium described herein, the first measurement gap may be associated with a first CSI report and the second measurement gap may be associated with a second CSI report.

### BRIEF DESCRIPTION OF THE DRAWINGS

FIG. 1 illustrates an example of a wireless communications system that supports concurrent or overlapping measurement gaps for layer one (L1) and layer three (L3) measurement in accordance with one or more aspects of the present disclosure.

FIG. 2 illustrates an example of a wireless communications system that supports concurrent or overlapping measurement gaps for L1 and L3 measurements in accordance with one or more aspects of the present disclosure.

FIG. 3 illustrates an example of a measurement configuration that support concurrent or overlapping measurement gaps for L1 and L3 measurements in accordance with one or more aspects of the present disclosure.

FIG. 4 illustrates an example of a wireless communications system that supports concurrent or overlapping measurement gaps for L1 and L3 measurements in accordance with one or more aspects of the present disclosure.

FIG. 5 illustrates an example of a measurement configuration that supports concurrent or overlapping measurement gaps for L1 and L3 measurements in accordance with one or more aspects of the present disclosure.

FIG. 6 illustrates an example of a process flow that supports concurrent or overlapping measurement gaps for L1 and L3 measurements in accordance with one or more aspects of the present disclosure.

FIGS. 7 and 8 illustrate block diagrams of devices that support concurrent or overlapping measurement gaps for L1 and L3 measurements in accordance with one or more aspects of the present disclosure.

FIG. 9 illustrates a block diagram of a communications manager that supports concurrent or overlapping measurement gaps for L1 and L3 measurements in accordance with one or more aspects of the present disclosure.

FIG. 10 illustrates a diagram of a system including a device that supports concurrent or overlapping measurement gaps for L1 and L3 measurements in accordance with one or more aspects of the present disclosure.

FIGS. 11 through 14 illustrate flowcharts showing methods that support concurrent or overlapping measurement gaps for L1 and L3 measurements in accordance with one or more aspects of the present disclosure.

FIGS. 15 and 16 illustrate block diagrams of devices that support concurrent measurement gaps for L1 and L3 measurements in accordance with one or more aspects of the present disclosure.

FIG. 17 illustrates a block diagram of a communications manager that supports concurrent measurement gaps for L1 and L3 measurements in accordance with one or more aspects of the present disclosure.

FIG. 18 illustrates a diagram of a system including a device that supports concurrent or overlapping measurement gaps for L1 and L3 measurements in accordance with one or more aspects of the present disclosure.

FIGS. 19 through 21 illustrate flowcharts showing methods that support concurrent or overlapping measurement gaps for L1 and L3 measurements in accordance with one or more aspects of the present disclosure.

### DETAILED DESCRIPTION

A user equipment (UE) may perform layer one (L1)/layer two (L2) mobility procedures, in which the UE may switch between candidate serving cells as it moves throughout a wireless communications system. In some cases, the UE may perform measurements of cells via different layers of a protocol stack (e.g., L1, L2, layer three (L3)). If the candidate serving cells are associated with different frequencies, the UE may perform inter-frequency measurements of cells. In addition, to account for the difference in frequencies, the UE may use measurement gaps during which the UE may switch between different candidate serving cells to accurately perform channel measurements. Specifically for L1 measurements, however, the UE may lack techniques to define concurrent measurement gaps, which may decrease efficiency and accuracy of channel measurements. Additionally, the UE may be unable to report a capability to support such measurement gaps.

The techniques described herein support the use of concurrent measurement gaps for L1 channel measurements. A UE may transmit a capability message indicating that the UE supports concurrent measurement gaps for L1 channel measurements. The UE may receive one or more signals indicating one or more measurement gaps associated with respective channel measurements (e.g., L1, L2, or L3 measurements), and the UE may select at least one or the measurement gaps to use for performing L1 channel measurements based on a scheduling collision between the one or more signaled measurement gaps. The UE may detect the scheduling collision based on an overlap in time or a distance in time between the measurement gaps. In some cases, the UE may perform an L1 channel measurement, an L3 channel measurement, or both using the selected measurement gaps, and the UE may transmit a channel state information (CSI) report in accordance with performing the channel measurements. In this way, the UE may decrease latency associated with performing the channel measurements and general L1/L2 mobility procedures.

Aspects of the disclosure are initially described in the context of wireless communications systems. Aspects of the disclosure are then described in the context of measurement configurations and process flows. Aspects of the disclosure are further illustrated by and described with reference to apparatus diagrams, system diagrams, and flowcharts that relate to using concurrent or overlapping measurement gaps for L1 and L3 measurements.

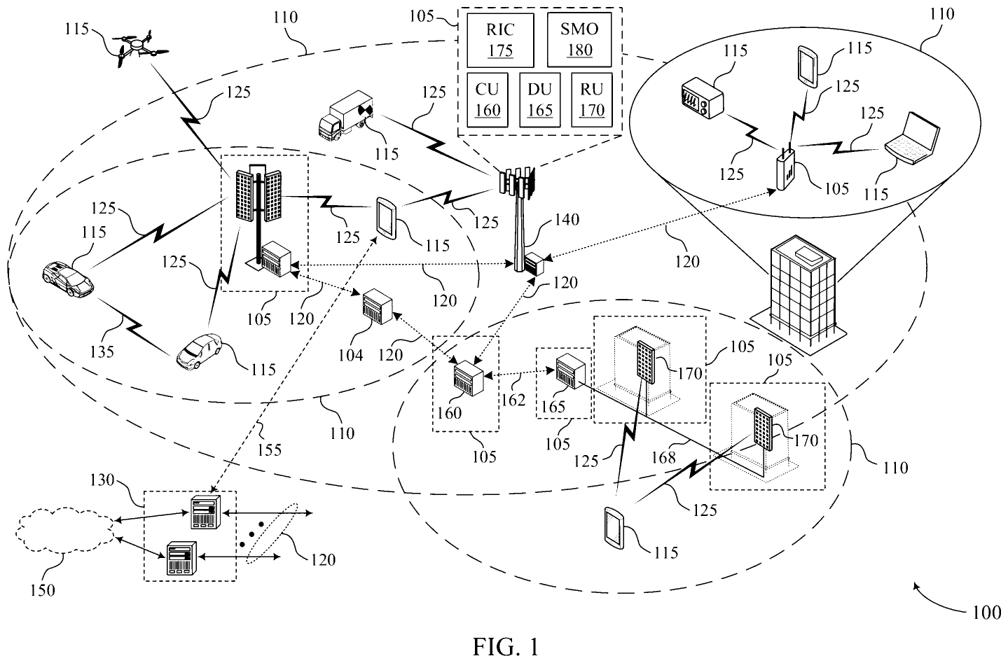

FIG. 1 illustrates an example of a wireless communications system 100 that support concurrent or overlapping measurement gaps for L1 and L3 measurements in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., L3, L2) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as L1 (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support concurrent or overlapping measurement gaps for L1 and L3 measurements as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may perform L1/L2 mobility procedures to handover from one serving cell to another in the wireless communications system 100. During such procedures, the UE 115 may measure different layers of a protocol stack (e.g., L1, L2, L3) to determine which cell to handover to. For example, the UE 115 may perform a channel or signal quality measurement (e.g., transmit power, SNR) of a target serving cell and report the measurement to a network entity 105, such that the network entity 105 may determine if the UE 115 is to handover to the target serving cell. The UE 115 may perform the channel measurements between a current serving cell and the target serving cell in a same frequency (e.g., an intra-frequency measurement) or in different frequencies (e.g., an inter-frequency measurement). To account for a difference in frequency between the current and target serving cells when performing inter-frequency measurements, the UE 115 may use a measurement gap. During a measurement gap, the UE 115 and the network entity 105 may refrain from transmitting or receiving signaling such that the UE 115 may switch to the target serving cell, perform channel measurements on that cell, and switch back to the current serving cell without dropping any transmissions.

In cases where a UE 115 may support active BWPs without synchronization signal blocks (SSBs), the UE 115 may perform L1 measurements outside of the active BWP (but within a configured bandwidth of a corresponding cell). For example, the UE 115 may support L1 SSB measurements outside of the active BWP with or without a measurement gap. In some examples of an L1/L2 mobility procedure, the UE 115 may be configured with a current, serving special cell (SpCell) and multiple candidate SpCells. During a handover procedure as the UE 115 moves throughout the wireless communications system 100, the UE 115 may switch from the current SpCell to one or the candidate SpCells (e.g., a new SpCell) based on higher layer signaling (e.g., L3 signaling). To decrease latency of this process, the UE 115 may switch between the SpCells based on lower layer signaling (e.g., L1/L2 signaling), which is associated with a lower latency. In some examples, the SpCells the UE 115 switches between may be intra-or inter-frequency cells. That is, L1/L2-based inter-cell mobility may be applicable to both intra-frequency and inter-frequency scenarios.

In some examples, the UE 115 may perform channel measurements associated with candidate serving cells to determine whether to handover between the cells. For example, the UE 115 may perform L3 intra-or inter-frequency measurements or L1 reference signal received power (RSRP) measurements. The UE 115 may use L3 intra-or inter-frequency measurements during an L3 handover procedure. For an L3 intra-frequency measurement, a measured SSB of a neighbor cell (e.g., a candidate serving cell) and a measured SSB of a current serving cell may have a same center frequency and a same sub-carrier spacing. That is, an L3 intra-frequency measurement may be defined as an SSB-based intra-frequency measurement provided the center frequency and the subcarrier spacing of the SSB of the serving cell indicated for measurement (e.g., the current serving cell) and the SSB of the neighbor cell are the same. Alternatively, an L3 inter-frequency measurement may be defined as an SSB-based inter-frequency measurement provided the center frequency and the subcarrier spacing of the SSBs are different (e.g., failing to satisfy the conditions of the intra-frequency case).

The UE 115 may use Ll RSRP measurement during an L1 handover procedure. The UE 115 may use an L1-RSRP measurement for reference signals in an active BWP, which may not require a measurement gap. In some cases, a network entity 105 may configure the UE 115 to perform L1-RSRP measurements of configured CSI-RS resources, SSB resources, or both for L1-RSRP. In addition, the UE 115 may perform the measurements for a serving cell, including a primary cell (PCell), a primary-secondary cell (PSCell), or a secondary cell (SCell), on the resources configured for the L1-RSRP measurements within the active BWP. As described herein, an SpCell may be equivalent to a PCell or a PSCell.

In some cases, however, the UE 115 may fail to support some cases of L1 channel measurements. Moreover, it may be unspecified whether a given L1 channel measurement scenario uses measurement gaps, which the UE 115 may use for both intra-frequency and inter-frequency scenarios. For example, the UE 115 may fail to support L1 measurements for cases in which an SSB of a measured candidate cell is outside of an active BWP but within a configured bandwidth of an activated or current serving cell (e.g., Case 1). Additionally, or alternatively, the UE 115 may fail to support L1 measurements for cases in which the SSB of the measured candidate cell is outside of the configured bandwidth of the activated serving cell. In some examples, the UE 115 may fail to support L1 measurements for cases in which the SSB of the measured candidate cell is within the active bandwidth but with a different center frequency or SCS from a measured SSB of the activated serving cell. That is, the UE 115 and the network entity 105 may lack information about how the UE 115 may perform L1 channel measurements for L1 mobility procedures, and whether measurement gaps may be used for such channel measurements, which may increase latency and decrease handover efficiency.

The wireless communications system 100 may support defining and reporting a capability of supporting concurrent measurement gaps for L1 channel measurements. In some examples, a UE 115 may transmit a capability message indicating its support of concurrent measurement gaps for channel measurements. In some cases, the capability message may include one or more information elements indicating the support of such measurement gaps for L1 channel measurements, L3 channel measurements, or both. The UE 115 may receive one or more signals indicating one or more measurement gaps associated with respective channel measurements (e.g., L1, L2, or L3 measurements). The UE 115 may select at least one or the measurement gaps to use for performing L1 channel measurements based on an overlap (e.g., scheduling collision) between the one or more signaled measurement gaps. That is, if two measurement gaps are at least partially overlapping in time, or if a distance in time between the two measurement gaps is smaller than a defined threshold, the concurrent measurement gaps may have a scheduling conflict that the UE 115 may consider when selecting one or more of the measurement gaps to use. The UE 115 may perform an L1 channel measurement, an L3 channel measurement, or both using the selected measurement gaps, and transmit a channel measurement report to a network entity in accordance with the measurement.

Additionally, or alternatively, a UE 115 may receive one or more signals identifying a set of channel measurements to be performed by the UE. The one or more signals may explicitly or implicitly indicate at least a first measurement gap associated with a first L1 measurement of the set of channel measurements and a second measurement gap associated with one or more of: a second L1 measurement of the set of channel measurements or a L2 measurement of the set of channel measurements. The UE 115 may select one of the first measurement gap or the second measurement gap to apply for the set of channel measurements at the UE according to a prioritization between the first measurement gap and the second measurement gap and an overlap in time between the first measurement gap and the second measurement gap. The UE 115 may perform at least a portion of the set of channel measurements based on the first measurement gap or the second measurement gap according to the selecting.

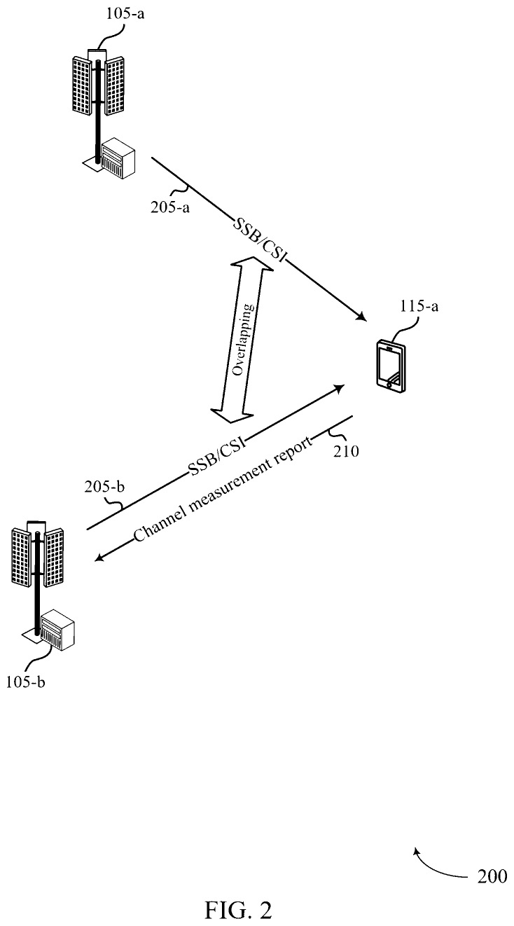

FIG. 2 illustrates an example of a wireless communications system 200 that supports concurrent or overlapping measurement gaps for L1 and L3 measurements in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a network entity 105-a, and a network entity 105-b. In some examples, the network entity 105-a may represent a current serving cell of the UE 115-a and the network entity 105-b may represent a candidate serving cell of the UE 115-a.

The wireless communications system 200 may support the UE 115-a using concurrent measurement gaps for performing L1 channel measurements during an L1/L2 mobility procedure. That is, the UE 115-a may define concurrent measurement gaps for L1 channel measurements and report its support of such concurrent measurement gaps. To reduce latency of L1/L2 mobility procedures, a network entity 105 may configure the UE 115-a with concurrent measurement gaps during which the UE 115-a may perform channel measurements of different candidate serving cells.

During a mobility procedure, the UE 115-a may measure one or more reference signals corresponding to each candidate serving cell. For example, the network entity 105-a may transmit SSBs or CSI 205-a, and the network entity 105-b may transmit SSBs or CSI 205-b. In some cases, such reference signals may collide or have a scheduling overlap in time. To enable the UE 115-a to measure the overlapping reference signals, the UE 115-a may support concurrent measurement gaps. Accordingly, the UE 115-a may transmit a capability message indicating a capability of the UE 115-a to support the concurrent measurement gaps for L1 channel measurements.

In some examples, the UE 115-a may report its capability to support the concurrent measurement gaps for L1 channel measurements in an information element that indicates a UE capability associated with L3 channel measurements. For example, the UE 115-a may transmit, via the capability message, a single UE capability information element (e.g., concurrentMeasGap-r17) indicating that the UE 115-a is capable of supporting concurrent measurement gaps for both L1 channel measurements and L3 channel measurements. The UE 115-a may indicate its capability in this information element if the UE 115-a defines concurrent measurement gaps for L1 channel measurements the same as for L3 channel measurements. In this way, the information element may indicate that the UE 115-a supports concurrent measurement gaps for both L1 and L3 channel measurements.

Alternatively, the UE 115-a may report its capability to support the concurrent measurement gaps for L1 channel measurements in a first information element that is separate from a second information element associated with L3 channel measurements. For example, the UE 115-a may transmit, via the capability message, a first UE capability information element (e.g., concurrentMeasGap-r18) indicating that the UE 115-a is capable of supporting concurrent measurement gaps for L1 channel measurements, where the first UE capability information element is separate from a second UE capability information element indicating whether the UE 115-a is capable of supporting concurrent measurement gaps for L3 channel measurements. The UE 115-a may indicate its capability in the first information element if the UE 115-a defines concurrent measurement gaps for L1 channel measurements based on that of L3 channel measurements.

The UE 115-a may be configured to perform at least some of a set of channel measurements for L1, L3, or both based on one or more configured measurement gaps. In some cases, the UE 115-a may receive one or more signals (e.g., measurement configuration signals) identifying a set of channel measurements and indicating at least a first measurement gap associated with a first L1 measurement of the set of channel measurements and a second measurement gap associated with one or more of a second L1 measurement of the set of channel measurements or an L3 measurement of the set of channel measurements. The first measurement gap and the second measurement gap may be concurrent, inter-frequency measurement gaps.

In some cases, the UE 115-a may select the first measurement gap, the second measurement gap, or both for performing L1 channel measurements or L3 channel measurements. For example, the UE 115-a may select one of the first measurement gap or the second measurement gap to apply for at least a portion of the set of channel measurements at the UE 115-a (e.g., L1/L3 measurements) according to a scheduling collision (e.g., an overlapping) between a first measurement gap occasion associated with the first measurement gap and a second measurement gap occasion associated with the second measurement gap. In some cases, the UE 115-a may detect the scheduling collision based on a partial or full overlap in time between the first measurement gap occasion and the second measurement gap occasion. In such cases, the UE 115-a may define the concurrent measurement gaps for L1 channel measurements the same as for L3 channel measurements, or based on that for L3 channel measurements (e.g., a simplified definition derived from that for L3 channel measurements).

Alternatively, the UE 115-a may detect the scheduling collision based on a timing between the first measurement gap occasion and the second measurement gap occasion in time being equal to or less than a defined threshold. For example, the UE 115-a may detect the scheduling collision if a distance in time between the two measurement gap occasions is, for example, equal to or smaller than a threshold or 4 ms. The distance between the two measurement gap occasions may be a time difference between an ending point (e.g., an end) of the first measurement gap occasion and a starting point (e.g., a beginning) of the second measurement gap occasion, where the first measurement gap occasion occurs earlier in time than the second measurement gap occasion. In some cases, more than two measurement gap occasions may overlap sequentially.

The UE 115-a may perform at least a portion of the set of channel measurements using the first measurement gap or the second measurement gap in accordance with the capability message. For example, the UE 115-a may measure the SSBs or CSI 205-a using the first measurement gap, the SSBs or CSI 205-b using the second measurement gap, or some combination thereof. In addition, the channel measurements may be associated with L1 or L3 signaling or processing at the UE with respect to a candidate serving cell. The UE 115-a may transmit a channel measurement report 210 in accordance with performing at least the portion of the set of channel measurements. That is, the channel measurement report 210 may indicate the results of the channel measurements. In some cases, the channel measurement report 210 may be a CSI report, where the first measurement gap may be associated with a first CSI report and the second measurement gap may be associated with a second CSI report.

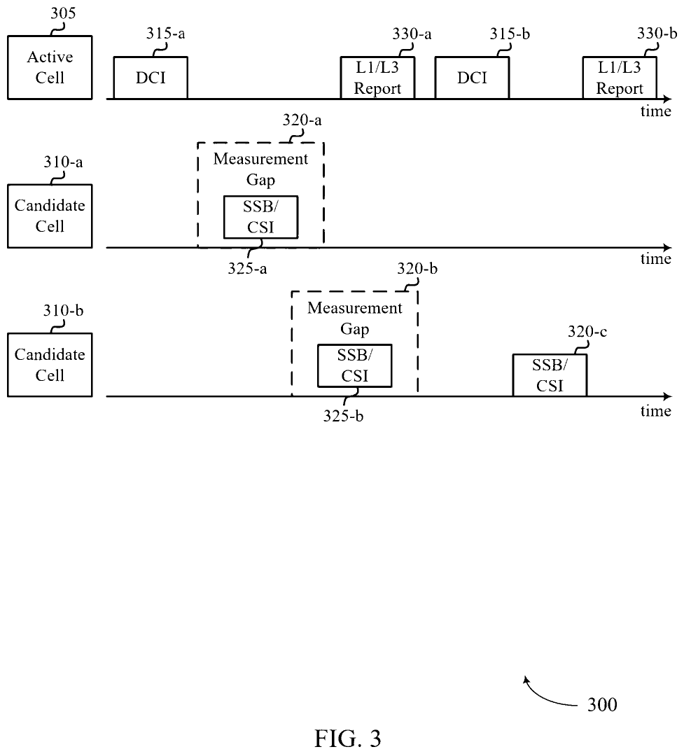

FIG. 3 illustrates an example of a measurement configuration 300 that supports concurrent or overlapping measurement gaps for L1 and L3 measurements in accordance with one or more aspects of the present disclosure. In some examples, the measurement configuration 300 may implement aspects of the wireless communications systems 100 and 200 or may be implemented by aspects of the wireless communications systems 100 and 200. For example, the measurement configuration 300 may be implemented by one or more of an active cell 305, a candidate cell 310-a, and a candidate cell 310-b. In some examples, the active cell 305 may be an active SpCell of a UE 115, the candidate cell 310-a may be a first candidate SpCell of the UE 115 at a first frequency (e.g., SpCell1), and the candidate cell 310-b may be a second candidate SpCell of the UE 115 at a second frequency (e.g., SpCell2). That is, the candidate cell 310-a and the candidate cell 310-b may operate using different frequencies or frequency ranges. The active cell 305 and the candidate cells 310 may be associated with one or more network entities 105 in wireless communications with the UE 115.

In some cases, the active cell 305 may trigger the UE 115 to perform some measurement and reporting for an L1/L2 mobility procedure. For example, the active cell 305 may transmit DCI 315-a triggering the UE 115 to perform an L1 measurement of the candidate cell 310-a and report the measurement. Because the frequencies of the candidate cell 310-a and the candidate cell 310-b may be different (e.g., resulting in the UE 115 performing inter-frequency measurements), a network entity 105 may configure the UE 115 with a measurement gap 320-a associated with a measured SSB or CSI 325-a or some other measured reference signal corresponding to the candidate cell 310-a. The measurement gap 320-a may provide the UE 115 a relatively larger time duration (e.g., time window) during which the UE 115 may measure one or more reference signals associated with the candidate cell 310-a. For example, the additional time enabled by the measurement gap 320-a may account for time uncertainties associated with an arrival time of one or more SSBs.

Additionally, or alternatively, the UE 115 may be configured with a measurement gap 320-b associated with a measured SSB or CSI 325-b or some other measured reference signal corresponding to the candidate cell 310-b. Like the measurement gap 320-a, the measurement gap 320-b may provide the UE 115 with a time window during which the UE 115 may measure one or more reference signals associated with the candidate cell 310-b.

In some cases, the measurement gap 320-a and the measurement gap 320-b may be concurrent measurement gaps. Regarding mobility procedures (e.g., L1/L2/L3 mobility procedures), the measurement gaps 320 may experience collisions or scheduling overlaps, which may impact intra-and inter-frequency measurements by the UE. In some cases, collisions between measurement gap occasions of two concurrent measurement gaps may occur if the measurement gaps 320 include two per-UE measurement gaps, two per-frequency measurement gaps in a same frequency or a same frequency range (e.g., intra-frequency measurement gaps), or one per-UE measurement gaps and one per-frequency measurement gap. When a network entity 105 configures the UE 115 with concurrent measurement gaps, the measurement gaps 320 may be considered as colliding if at least the two corresponding measurement gap occasions are fully or partially overlapping in a time domain or a distance in time between the two measurement gap occasions is, for example, equal to or smaller than 4 ms. In some examples, the distance may be a time difference between an ending point of the measurement gap 320-a and a starting point of the measurement gap 320-b, where the measurement gap 320-a occurs earlier in time than measurement gap 320-b. In some cases, more than two measurement gaps 320 may overlap sequentially.

In some examples, in the case of a scheduling conflict between the measurement gaps 320 in a mobility procedure (e.g., an L1/L2/L3 mobility procedure), the UE 115 may perform reference signal measurements in a measurement gap occasion associated with a measurement gap 320 with a higher priority, and the UE 115 may drop the measurement gap occasion associated with a relatively lower priority. In this way, the UE 115 may transmit or receive reference signals via serving cells that are not interrupted. In some examples, the UE 115 may refrain from applying such a selection process when the network entity 105 configures a measurement gap 320 without an assigned priority simultaneously with one or more measurement gaps 320 that affect serving carrier in a same frequency range, and when the measurement gaps 320 with and without assigned priorities are colliding with each other. That is, the UE 115 may use techniques other than a priority comparison to select measurement gaps 320 if not all configured measurement gaps 320 are assigned a priority. In some cases, the network entity 105 may configure a priority for a measurement gap 320 via gapPriority in GapConfig. The requirements of the concurrent measurement gaps 320 may apply provided that the network entity 105 configures the two measurement gaps 320 colliding with each other with different priorities.

The UE 115 may transmit an L1 report 330-a via a physical uplink shared channel (PUSCH). The L1 report 330-a may include or indicate the measured SSB or CSI 325-a, the measured SSB or CSI 325-b, or both, based on the measurement gap 320-a, the measurement gap 320-b, or both being configured for the UE 115. That is, the UE 115 may transmit a channel measurement report in accordance with performing one or more channel measurements based on the measurement gaps 320. In some cases, the UE 115 may receive DCI 315-b triggering the UE 115 to perform an L1 measurement of the candidate cell 310-b and report the measurement. The UE 115 may measure one or more reference signals associated with the candidate cell 310-b (without a measurement gap) and transmit a PUSCH with an L1/L3 report 330-b including the measured SSB/CSI 320-c.

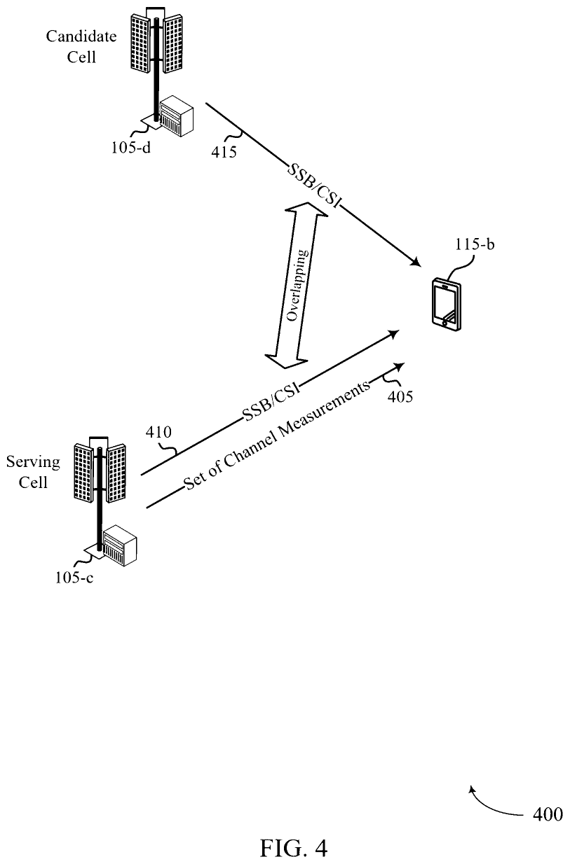

FIG. 4 illustrates an example of a wireless communications system 400 that supports concurrent or overlapping measurement gaps for L1 and L3 measurements in accordance with one or more aspects of the present disclosure. The wireless communications system 400 may implement aspects of the wireless communications systems 100 and 200. The wireless communications system 400 may include a UE 115-b, a network entity 105-c, and a network entity 105-d. In some aspects, the network entity 105-c may be a serving cell of the UE 115-b while the network entity 105-d may be a candidate cell of the UE 115-b.

A UE 115-b may perform L1/L2 mobility procedures to handover from one serving cell to another in the wireless communications system 400. During such procedures, the UE 115-b may monitor or measure a channel according to different layers of a protocol stack (e.g., L1, L2, L3) to determine which cell to handover to. For example, the UE 115-b may perform a channel or signal quality measurement (e.g., transmit power or SNR) of a target serving cell (such as the network entity 105-d) and report the measurement to its service call (e.g., such as the network entity 105-c), such that the service cell may determine if the UE 115-b is to handover to the target serving cell. The UE 115-b may perform the channel measurements between a current serving cell and the target serving cell in a same frequency (e.g., intra-frequency measurements) or in different frequencies (e.g., inter-frequency measurements). To account for a difference in frequency between the current and target serving cells when performing inter-frequency measurements, the UE 115-b may use a measurement gap. During a measurement gap, the UE 115-b and the cell(s) may refrain from transmitting or receiving signaling such that the UE 115-b may switch to the target serving cell, perform channel measurements on that cell, and switch back to the current serving cell without dropping any transmissions.

In cases where a UE 115-b may support active BWPs without SSBs, the UE 115-b may perform L1 measurements outside of the active BWP (but within a configured bandwidth of a corresponding cell). For example, the UE 115-b may support L1 SSB measurements outside of the active BWP with or without a measurement gap. In some examples of an L1/L2 mobility procedure, the UE 115-b may be configured with a current, serving special cell (SpCell) and multiple candidate SpCells. During a handover procedure as the UE 115-b moves throughout the wireless communications system 400, the UE 115-b may switch from the current SpCell to one or the candidate SpCells (e.g., a new SpCell) based on higher layer signaling (e.g., L3 signaling). To decrease latency of this process, the UE 115-b may switch between the SpCells based on lower layer signaling (e.g., L1/L2 signaling), which is associated with a lower latency. In some examples, the SpCells of the UE 115-b may be intra-or inter-frequency cells. That is, L1/L2-based inter-cell mobility may be applicable to both intra-frequency and inter-frequency scenarios.

In some examples, the UE 115-b may perform channel measurements associated with candidate serving cells to determine whether to handover between the cells. For example, the UE 115-b may perform L3 intra-or inter-frequency measurements or L1 RSRP measurements. The UE 115-b may use L3 intra-or inter-frequency measurements during an L3 handover procedure. For an L3 intra-frequency measurement, a measured SSB of a neighbor cell (e.g., a candidate serving cell, such as the network entity 105-d) and a measured SSB of a current serving cell (e.g., such as the network entity 105-c) may have a same center frequency and a same sub-carrier spacing. That is, an L3 intra-frequency measurement may be defined as an SSB-based intra-frequency measurement provided the center frequency and the subcarrier spacing of the SSB of the serving cell indicated for measurement (e.g., the current serving cell) and the SSB of the neighbor cell are the same. Alternatively, an L3 inter-frequency measurement may be defined as an SSB-based inter-frequency measurement provided the center frequency and the subcarrier spacing of the SSBs are different (e.g., failing to satisfy the conditions of the intra-frequency case).

The UE 115-b may use L1 RSRP measurement during an L1 handover procedure. The UE 115-b may use an L1-RSRP measurement for reference signals in an active BWP, which may not require a measurement gap. In some cases, a network entity (e.g., the service cell, such as the network entity 105-c) may configure the UE 115-b to perform L1-RSRP measurements of configured CSI-RS resources, SSB resources, or both for L1-RSRP. In addition, the UE 115-b may perform the measurements for a serving cell, including a primary cell (Pcell), a primary-secondary cell (PSCell), or a secondary cell (SCell), on the resources configured for the L1-RSRP measurements within the active BWP. As described herein, an SpCell may be equivalent to a PCell or a PSCell.

In some cases, however, the UE 115-b may fail to support some cases of L1 channel measurements. Moreover, it may be unspecified whether a given L1 channel measurement scenario uses measurement gaps, which the UE 115-b may use for both intra-frequency and inter-frequency scenarios. For example, the UE 115-b may fail to support L1 measurements for cases in which an SSB of a measured candidate cell is outside of an active BWP but within a configured bandwidth of an activated or current serving cell (e.g., Case 1). Additionally, or alternatively, the UE 115-b may fail to support L1 measurements for cases in which the SSB of the measured candidate cell is outside of the configured bandwidth of the activated serving cell. In some examples, the UE 115-b may fail to support L1 measurements for cases in which the SSB of the measured candidate cell is within the active bandwidth but with a different center frequency or SCS from a measured SSB of the activated serving cell. That is, the UE 115-b and the network entity 105-c may lack information about how the UE 115 may perform L1 channel measurements for L1 mobility procedures, and whether measurement gaps may be used for such channel measurements, which may increase latency and decrease handover efficiency.

Moreover, regarding L3 mobility procedures, L3 concurrent measurement gaps may experience collisions or scheduling overlaps, which may impact L3 intra-and inter-frequency measurements. In some cases, collisions between measurement gap occasions of two concurrent measurement gaps may occur if the two measurement gaps include two per-UE measurement gaps, two per-frequency measurement gaps in a same frequency or a same frequency range (e.g., intra-frequency measurement gaps), or one per-UE measurement gaps and one per-frequency measurement gap. When a network entity 105-c configures the UE 115-b with concurrent measurement gaps, two measurement gaps may be considered as colliding or overlapping, at least to some degree, if at least the two corresponding measurement gap occasions are fully or partially overlapping in a time domain or a distance between the two measurement gap occasions is, for example, equal to or smaller than 4 ms. In some examples, the distance may be a time difference between an ending point (e.g., an end) of a first measurement gap occasion and a starting point (e.g., a beginning) of a second measurement gap occasion, where the first measurement gap occasion occurs earlier in time than the second measurement gap occasion. In some cases, more than two measurement gap occasions may overlap sequentially.

In some examples, in the case of a collision between two measurement gap occasions in an L3 mobility procedure, the UE 115-b may perform measurements in a measurement gap occasion associated with a measurement gap with a higher priority, and the UE 115-b may drop the measurement gap occasion associated with a relatively lower priority. In this way, the UE 115-b may transmit or receive reference signals in corresponding serving cells that are not interrupted. In some examples, the UE 115-b may refrain from applying such a selection process when the network entity 105-c configures a measurement gap without an assigned priority simultaneously with one or more measurement gaps that affect serving carrier in a same frequency range, and when the measurement gaps with and without assigned priorities are colliding with each other. That is, the UE 115-b may use techniques other than a priority comparison to select measurement gaps if not all configured measurement gaps are assigned a priority. In some cases, the network entity 105-c may configure a priority for a measurement gap via gapPriority in GapConfig. The requirements of the concurrent measurement gaps may apply provided that the network entity 105-c configures the two measurement gaps colliding with each other with different priorities. While these selection criteria apply to L3 mobility procedures, the UE 115-b may lack comparable criteria for L1 mobility procedures.

The wireless communications system 400 may support defining and reporting a capability of supporting concurrent measurement gaps for L1 channel measurements and L1/L3 measurements. In some examples, a UE 115-b may transmit a capability message indicating its support of concurrent measurement gaps for L1 plus L1/L3 overlapping channel measurements. In some cases, the capability message may include one or more information elements indicating the support of such measurement gaps for L1 channel measurements, L3 channel measurements, or both. The UE 115-b may receive signal(s) 405 indicating one or more measurement gaps associated with respective channel measurements (e.g., a first set of L1 channel measurements and a second set of L1 or L3 channel measurements). The UE 115-b may select at least one or the measurement gaps to use for performing L1 or L3 channel measurements based on an overlap (e.g., scheduling collision) between the one or more signaled measurement gaps. That is, if two measurement gaps are at least partially overlapping in time, or if a distance between the two measurement gaps is smaller than a defined threshold (such as a standardized threshold known by the UE 115-b or a threshold signaled to the UE 115-b by the network entity 105-c), the concurrent measurement gaps may have a scheduling conflict that the UE 115-b may consider when selecting one or more of the measurement gaps to use. The UE 115-b may perform an L1 channel measurement, an L3 channel measurement, or both, using the selected measurement gaps, and transmit a channel measurement report to a network entity 105-c in accordance with the measurement.

In some aspects, the wireless communications system 400 may support defining techniques for the UE 115-b to select between overlapping measurement gaps for L1 and L1/L3 channel measurements. For example, the network entity 105-c may transmit or otherwise provide (and the UE 115-b may receive or otherwise obtain) signal(s) 405 that identify a set of channel measurements for the UE 115-b. For example, the signal(s) 405 may include separate or composite signaling identifying a first measurement gap and a second measurement gap. In some aspects, the first measurement gap and the second measurement gap collide (e.g., overlap, at least to some degree, in the time domain, which may include fewer than a 4 ms separation between the ending of the first measurement gap and the beginning of the second measurement gap). The second measurement gap may be another L1 measurement gap (e.g., a second L1 measurement gap) or a L3 measurement gap.

In some aspects, the set of channel measurements may include measurement configurations for the serving cell of the UE 115-b (e.g., the network entity 105-c) and/or for one or more candidate cell(s) for UE 115-b. The candidate cell(s) may include neighboring cells to be monitored for a potential handover procedure of the UE 115-b from the network entity 105-c to the network entity 105-d. In other examples, the candidate cell(s) may include neighboring cells that may be added for wireless communications with the UE 115-b, e.g., to be added as new SCell(s). The set of channel measurements may be separately signaled (more than one signals) for each the serving cell and candidate cell(s), e.g., in separate RRC signaling, DCI signaling, medium access control-control element (MAC-CE) signaling, or some combination of such signaling. The set of channel measurements may be signaled in one signal for each cell, in some examples. In some examples, the set of channel measurements may be signaled for multiple cells associated with the same network entity.

In some aspects, each measurement gap may correspond to the time and/or frequency resources allocated to each configured cell. That is, each set of measurements may identify or otherwise indicate which time resources, frequency resources, and/or spatial resources the associated cell will transmit one or more signals to be measured by the UE 115-b. The measurement gap, from the perspective of the UE 115-b may indicate the time period during which the UE 115-b tunes to the allocated resources and monitors for the signal to be measured. Upon measuring the signal from the cell, the UE 115-b may determine the channel performance characteristics (e.g., CSI, interference level, load, throughput, or synchronization) to be reported in a measurement report transmitted to the serving cell (e.g., the network entity 105-c). For intra-frequency measurements between the cells, the UE 115-b may not be required to perform retuning operations between measurements and, therefore, the duration of the measurement gap may be shortened. For inter-frequency measurements between the cells, the UE 115-b may perform retuning operations between measurements and, therefore, the duration of the measurement gap may be longer relative to intra-frequency measurement gaps.

Accordingly, the set of channel measurements may include a first measurement gap associated with first channel measurements and a second measurement gap associated with second channel measurements. This is illustrated in FIG. 2 where the network entity 105-c transmits or otherwise provides a SSB, CSI-RS, or some other reference, tracking, or synchronization signal (e.g., SSB/CSI-RS signaling 410) and the network entity 105-d transmits or otherwise provides a SSB, CSI-RS or some other reference, tracking or synchronization signal (e.g., the SSB/CSI-RS signaling 415). The UE 115-b may generally be configured to measure both signals provided by the network entity 105-c and the network entity 105-d and report the results of the channel measurements to the network entity 105-c in a feedback message.

However, in some examples the first measurement gap and the second measurement gap may overlap, at least to some degree, in the time domain. That is, the time period during which the UE 115-b is scheduled to monitor for the SSB/CSI-RS signaling 410 from the network entity 105-c overlaps with (or is not sufficiently separated from) the time period during which the UE 115-b is scheduled to monitor for the SSB/CSI-RS signaling 415 from the network entity 105-d. Again, the first measurement gap may be associated with a L1 measurement and the second measurement gap may be associated with another L1 measurement or an L3 measurement.

Accordingly, the UE 115-b may generally select between the first measurement gap and the second measurement gap (e.g., the overlapping gaps) due to the overlap in the time domain. That is, in some examples the first measurement gap and the second measurement gap may be associated with inter-frequency measurements where the UE 115-b would need to perform retuning operations between measurements. In other examples, the first measurement gap and the second measurement gap may be associated with intra-frequency measurements, but may overlap in the time domain a sufficient amount that the UE 115-b is unable to monitor for both signals at the same time. Accordingly, the UE 115-b may select between the measurement gaps that overlap in the time domain. The UE 115-b may then perform at least a portion of the set of channel measurements based on the selecting. For example, the UE 115-b may perform the first L1 channel measurements when the first measurement gap is selected or may perform the second L1 or L3 channel measurements when the second measurement gap is selected, or vice versa when the second measurement gap is selected.

In some aspects, when the UE 115-b is configured with multiple measurement gaps for different L1 inter-frequency CSI reports and different L1 or L3 inter-frequency CSI reports and when any two of the multiple measurement gaps are overlapping or considered as concurrent measurement gaps, the UE 115-b may perform channel measurements for measurement gaps based on the techniques described herein.

In some examples, the selecting may be based on a prioritization between the first and second measurement gaps. For example, the first measurement gap may be a measurement gap identified in a first channel measurement and the second measurement gap may be a measurement gap identified in a second channel measurement. The first measurement may carry or otherwise convey an indication of a first priority level associated with the first measurement gap. The second measurement may carry or otherwise convey an indication of a second priority level associated with the second measurement gap. The UE 115-b may select the measurement gap associated with the highest priority between the first and second measurement gaps (e.g., based on the first priority level and second priority level). In some aspects, this may provide a unified prioritization rule for all types of L1 and L1 or L3 CSI measurements and reporting. One non-limiting example may include the unified prioritization rule being based on the order of gapPriority associated with the measurement gap configuration.

Additionally, or alternatively, the selecting may be based on a periodicity of the measurement gaps. For example, the UE 115-b may select the first or second measurement gap based on a prioritization based on a first periodicity associated with the first measurement gap and a second periodicity associated with the second measurement gap. That is, the first measurement may include a first periodicity for the first measurement gap and the second measurement may include a second periodicity for the second measurement gap. The periodicity for a measurement gap may generally define how often the allocated resources are repeated for channel measurements. The periodicity may be periodic (e.g., regularly scheduled), semi-persistent (e.g., semi-periodic), or aperiodic (e.g., on-demand) in nature. In some examples, this may provide a fixed prioritization rule based on the periodicity of the measurement gaps. As one non-limiting example, such a fixed rule may include aperiodic measurement gaps being given a higher priority than semi-persistent measurement gaps and with semi-persistent measurement gaps being given a higher priority than periodic measurement gaps.

Additionally, or alternatively, the selecting may be based on the type associated with the measurement gaps. For example, the UE 115-b may select the first or second measurement gap based on a prioritization based on a first priority level of the type in which the channel measurements occur. That is, the techniques provided herein provide for the set of channel measurements to include at least one L1 measurement and either another L1 measurement or an L3 measurement. The type of L1 measurement may be associated with a first priority level and the type of L3 measurement may be associated with a second priority level. The priority level of the type associated with the measurement gap may be used by the UE 115-b to select the measurement gap between the first and second measurement gaps. In some examples, the first priority level of the L1 measurement may be given a higher priority level than the second priority level of the L3 measurement. In other examples, the first priority level of the L1 measurement may be given a lower priority level than the second priority level of the L3 measurement. Accordingly, this may provide a fixed rule to prioritize one type of CSI measurement and reporting over another type. As one non-limiting example, this may include L3 measurement being prioritized (e.g., associated with a higher priority level) over L1 measurements. That is, in this example the channel measurement associated with L3 measurements may be prioritized over the ones associated with L1 measurement.

In some examples, the UE 115-b may be configured with multiple measurement gaps for L1 inter-frequency CSI reports of the same or different periodicities. When any two of the measurement gaps are overlapping or considered as concurrent measurement gaps, the UE 115-b may be configured to apply a prioritization rule for the measurement gap according to the techniques described herein. Such techniques may provide a mechanism for the UE 115-b to select between overlapping measurement gaps for L1 inter-frequency CSI measurement and reporting. In some examples, this may additionally, or alternatively, include the techniques for selecting between the first and second measurement gaps discussed above.

Additionally, or alternatively, the selecting may be based on the traffic being communicated on the channel being measured. For example, the UE 115-b may select the first or second measurement gap based on a prioritization based on a first priority level associated with the traffic to be communicated based on the result of the first L1 measurement and a second priority level associated with the traffic to be communicated based on a result of the second L1 measurement or L3 measurement. This generally adopts a physical layer prioritization rule associated with the uplink transmission of CSI reports. As one non-limiting example, this may include a measurement gap associated with an uplink transmission (e.g., physical uplink shared channel (PUSCH) transmission) having a higher physical priority than the uplink transmission (e.g., PUSCH) having a lower physical priority.

Additionally, or alternatively, the selecting may be based on the transmission of the CSI reports. For example, the UE 115-b may select the first or second measurement gap based on a prioritization based on a first priority level associated with a first CSI report to be communicated based on a result of the first L1 measurement and a second priority level associated with a second CSI report to be communicated based on a result of the second L1 measurement or the L3 measurement. That is, the first CSI report may be associated with the same or a different periodicity and/or physical layer priority than the second CSI report. Each CSI report may also be associated with unique CSI report identifiers (e.g., ID numbers). The priority level of the CSI reports may be based on the differences between the periodicities and/or the physical layer priority of each of the first and second CSI reports. When the periodicities and/or physical layer priority are the same, the identifiers of the CSI reports may be used to define the priority level (e.g., CSI report with lower identifier is given priority over CSI report with higher identifier). This may provide a prioritization rule used for the transmission of the CSI reports to be considered during measurement gap selection.

Additionally, or alternatively, the selecting may be based on the periodicity of the CSI reports. For example, the UE 115-b may select the first or second measurement gap based on a prioritization based on a first priority level associated with a first periodicity for the first CSI report to be communicated based on a result of the first L1 measurement and a second priority level associated with a second periodicity for the second CSI report to be communicated based on a result of the second L1 measurement or the L3 measurement. This may provide a prioritization rule based on the corresponding periodicity of the CSI reports. For example, this may be applied when the CSI report have the same uplink physical layer priority. In this example, the measurement gap associated with an aperiodic CSI report may be given a higher priority level than a semi-persistent CSI report and the semi-persistent CSI report may be given a higher priority level than a periodic CSI report.

Aspects of the examples and techniques discussed above may be applied when the gapPriority is not configured or when the gapPriority is the same for the concurrent measurement gaps (e.g., for the first and second measurement gaps).

Accordingly, the UE 115-b may perform at least a portion of the set of measurement according to the selecting. That is, the UE 115-b may perform channel measurements using the first measurement gap or the second measurement gap, with the measurement gap being selected based on the techniques discussed herein. The UE 115-b may transmit or otherwise provide (and the network entity 105-c may receive or otherwise obtain) a channel measurement report according to the performing. For example, the channel measurement report may carry or otherwise indicate a result of the channel measurements performing during the selected first measurement gap or second measurement gap.

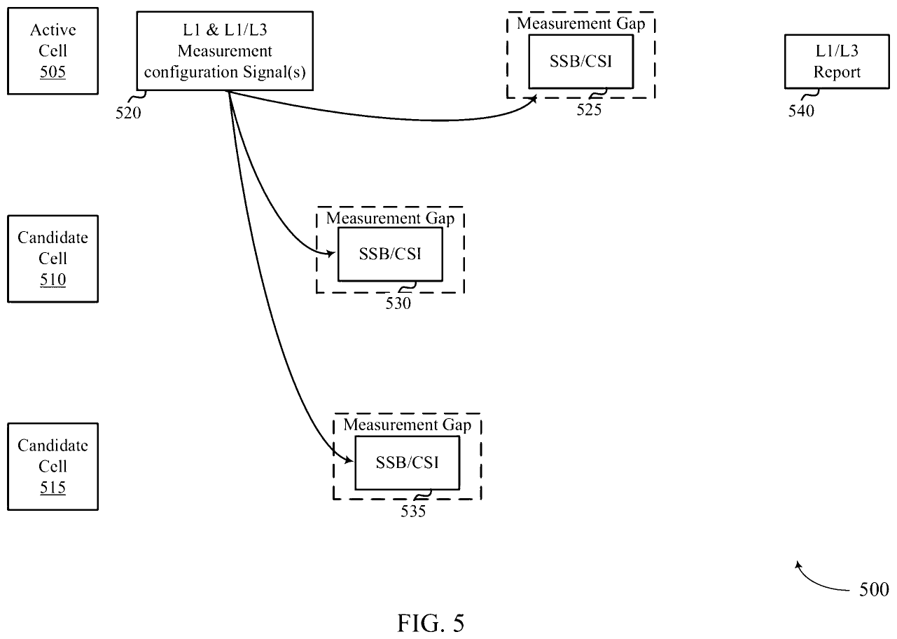

FIG. 5 illustrates an example of a measurement gap configuration 500 that supports concurrent or overlapping measurement gaps for layer one and layer three measurements in accordance with one or more aspects of the present disclosure. Measurement gap configuration 500 may implement aspects of wireless communications systems 100 and/or 200. Aspects of measurement gap configuration 500 may be implemented at or implemented by an active cell 505, a candidate cell 510, and a candidate cell 515, which may be examples of the corresponding devices described herein. For example, the active cell 505, the candidate cell 510, and/or the candidate cell 515 may be examples of one or more network device(s).

As discussed above, aspects of the techniques described herein provide mechanisms for a UE 115 to select between overlapping measurement gaps for L1 and another L1 or an L3 measurement. For example, the UE 115 may receive signal(s) 520 identifying a set of channel measurements. The set of channel measurement may include a channel measurement (e.g., a configuration or set of parameters to be used to perform channel measurements) for a service cell (e.g., the active cell 505) and one or more candidate cells, with two candidate cells being shown in FIG. 5 by way of example only. In some aspects, the signal(s) 520 may include one signal identifying or otherwise indicating the set of channel measurements or separate signaling being used to identify or otherwise indicate separate channel measurements in the set of channel measurements. For example, the signal(s) 520 may include a signal identifying SSB/CSI signal 530 and another signal identifying SSB/CSI signal 535. Each channel measurement in the set of channel measurements may identify the time resources, frequency resources, spatial resources, and/or code resources that the UE 115 is to monitor to detect a signal (e.g., SSB/CSI) transmitted from the serving or candidate cell. The set of channel measurements may include at least one L1 measurement and either another L1 measurement or an L3 measurement.

In the non-limiting example illustrated in FIG. 5, the set of channel measurements may include a first measurement of signal 525 (e.g., SSB, CSI-RS, or another reference, tracking, or synchronization signal) associated with the active cell 505 during a first measurement gap. The first measurement may include a first CSI report identified by a first CSI report identifier. The first measurement may include a first CSI periodicity, a first CSI report priority level, and other information associated with the CSI measurement and reporting. Similarly, the set of channel measurements may include a second measurement of the SSB/CSI signal 530 associated with the candidate cell 510 during a second measurement gap. The second measurement may include a second CSI report identified by a second CSI report identifier. The second measurement may include a second CSI periodicity or a second CSI report priority level. Lastly, the set of channel measurements may include a third measurement of the SSB/CSI signal 535 associated with the candidate cell 515 during a third measurement gap. The third measurement may include a third CSI report identified by a third CSI report identifier. The third measurement may include a third CSI periodicity or a third CSI report priority level.

At least one channel measurement in the set of channel measurements may be an L1 measurement. At least one other channel measurement in the set of channel measurements may include another L1 measurement or an L3 measurement.

However, the second measurement gap and the third measurement gap may be overlapping measurement gaps (e.g., overlapping in the time domain or without a sufficient threshold separation time). Accordingly, the UE 115 may select the second measurement gap (a first measurement gap in this context) or the third measurement gap (a second measurement gap in this context) according to a prioritization between the second and third measurement gaps. The UE 115 may then perform at least a portion of the set of channel measurements according to the selecting (e.g., using the second or third measurement gap). For example, the prioritization may be based on the priority level of each measurement gap, the periodicity of each measurement gap, the physical layer (e.g., L3 or L1 measurements), or the traffic priority, for the channel associated with the channel measurements.

The UE 115 may transmit or otherwise provide a channel measurement report 540 indicating a result of the channel measurements. The channel measurement report 540 may be transmitted to the active cell 505 of the UE 115.

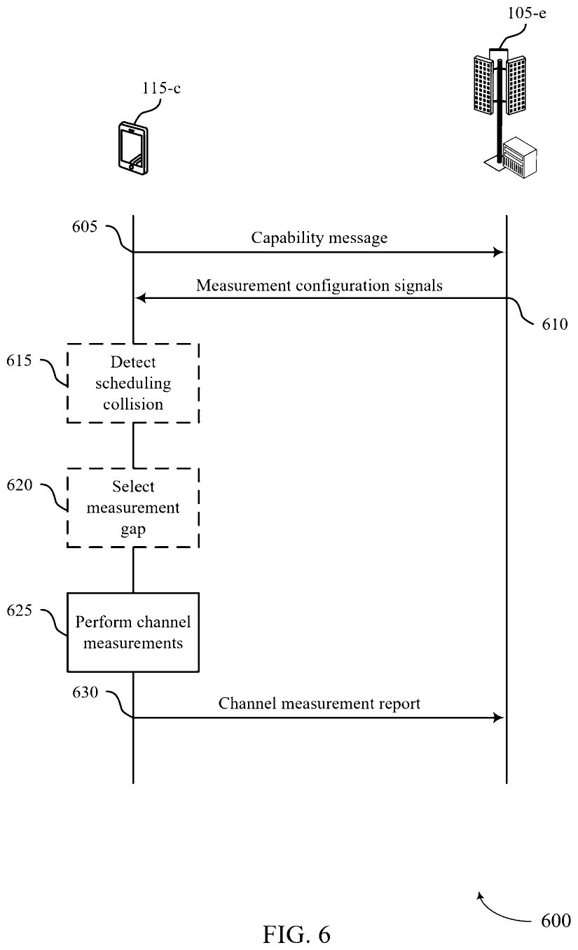

FIG. 6 illustrates an example of a process flow 600 that supports concurrent or overlapping measurement gaps for L1 and L3 measurements in accordance with one or more aspects of the present disclosure. The process flow 600 may implement aspects of wireless communications systems 100 and 200, or may be implemented by aspects of the wireless communications systems 100 and 200. For example, the process flow 600 may illustrate operations between a UE 115-c and a network entity 105-e (e.g., a serving cell), which may be examples of corresponding devices described herein. In the following description of the process flow 600, the operations between the UE 115-c and the network entity 105-e may be transmitted in a different order than the example order shown, or the operations performed by the UE 115-c and the network entity 105-e may be performed in different orders or at different times. Some operations may also be omitted from the process flow 600, and other operations may be added to the process flow 600.

At 605, the UE 115-c may transmit a capability message indicating a capability of the UE 115-c to support concurrent measurement gaps for L1 channel measurements. In some cases, the capability message may include one or more UE capability information elements indicating the UE's capability to support concurrent measurement gaps for L1 channel measurements, L3 channel measurements, or both.

At 610, the UE 115-c may receive one or more measurement configuration signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements. The channel measurements may include SSB measurements, CSI measurements, or other reference signal measurements. In addition, the measurement gaps may be concurrent, inter-frequency measurement gaps (e.g., the first measurement gap may be associated with a different frequency than the second measurement gap).

At 615, the UE 115-c may detect a scheduling collision between a first measurement gap occasion associated with the first measurement gap and a second measurement gap occasion associated with the second measurement gap. For example, the UE 115-c may detect the scheduling collision based on a partial or full overlap in time between the first measurement gap occasion and the second measurement gap occasion, a timing between the first measurement gap occasion and the second measurement gap occasion being equal to or less than a defined threshold (e.g., 6 ms), or both.

At 620, the UE 115-c may select one of the first measurement gap or the second measurement gap to apply for at least a portion of the set of channel measurements at the UE according to the detected scheduling collision. For example, the UE 115-c may select the first measurement gap for L1 channel measurements and the second measurement gap for L3 channel measurements.

At 625, the UE 115-c may perform at least a portion of the set of channel measurements using the first measurement gap or the second measurement gap in accordance with the capability message. For example, the UE 115-c may measure one or more reference signals (e.g., SSBs, CSI-RSs) during the first or second measurement gap for one or more candidate serving cells of the UE 115-c.

At 630, the UE 115-c may transmit a channel measurement report in accordance with performing at least the portion of the set of channel measurements. For example, the UE 115-c may transmit a first CSI report associated with the first measurement gap and a second CSI report associated with the second measurement gap.

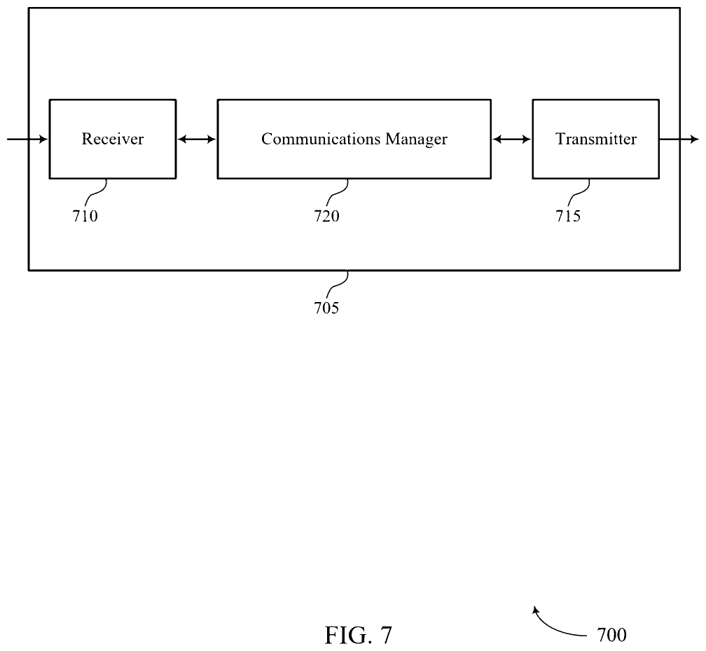

FIG. 7 illustrates a block diagram 700 of a device 705 that supports concurrent or overlapping measurement gaps for L1 and L3 measurements in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to using concurrent or overlapping measurement gaps for L1 and L3 measurements). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to using concurrent or overlapping measurement gaps for L1 and L3 measurements). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of concurrent or overlapping measurement gaps for L1 and L3 measurements as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in hardware, software (e.g., executed by a processor), or any combination thereof. If implemented in code executed by a processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for transmitting a capability message indicating a capability of the UE to support concurrent measurement gaps for L1 channel measurements. The communications manager 720 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements. The communications manager 720 may be configured as or otherwise support a means for performing at least a portion of the set of channel measurements using the first measurement gap or the second measurement gap in accordance with the capability message. The communications manager 720 may be configured as or otherwise support a means for transmitting a channel measurement report in accordance with performing at least the portion of the set of channel measurements.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for using concurrent measurement gaps for L1 channel measurements, which may reduce latency and improve UE mobility.

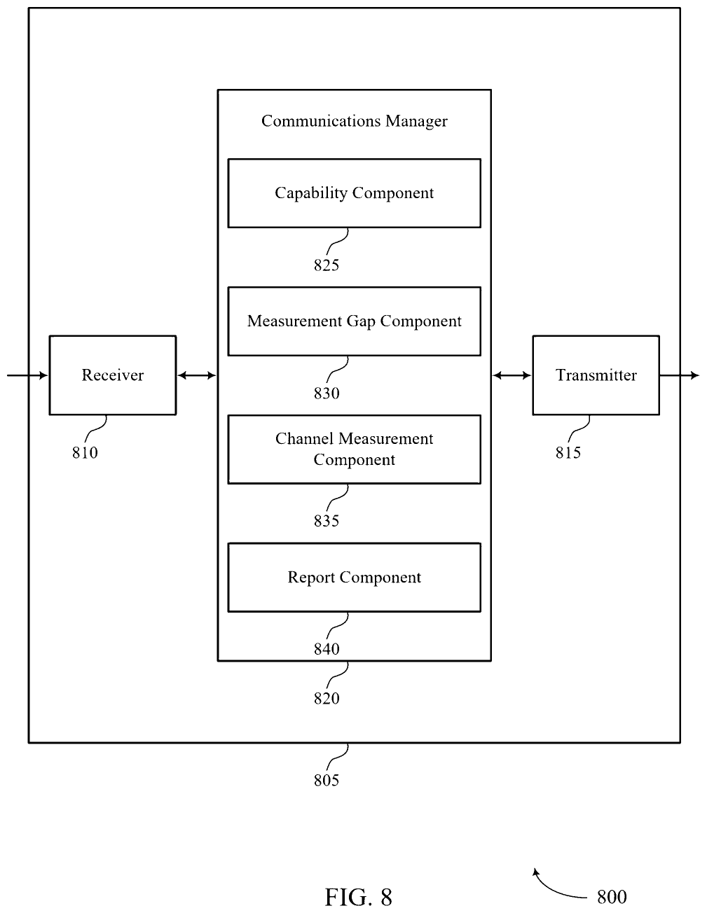

FIG. 8 illustrates a block diagram 800 of a device 805 that supports concurrent or overlapping measurement gaps for L1 and L3 measurements in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to using concurrent or overlapping measurement gaps for L1 and L3 measurements). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to using concurrent or overlapping measurement gaps for L1 and L3 measurements). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of concurrent or overlapping measurement gaps for L1 and L3 measurements as described herein. For example, the communications manager 820 may include a capability component 825, a measurement gap component 830, a channel measurement component 835, a report component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The capability component 825 may be configured as or otherwise support a means for transmitting a capability message indicating a capability of the UE to support concurrent measurement gaps for L1 channel measurements. The measurement gap component 830 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements. The channel measurement component 835 may be configured as or otherwise support a means for performing at least a portion of the set of channel measurements using the first measurement gap or the second measurement gap in accordance with the capability message. The report component 840 may be configured as or otherwise support a means for transmitting a channel measurement report in accordance with performing at least the portion of the set of channel measurements.

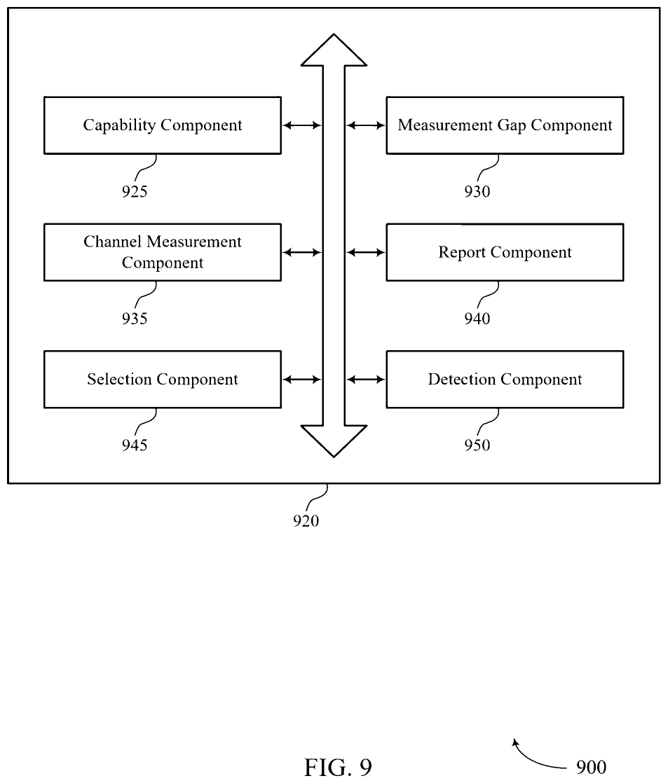

FIG. 9 illustrates a block diagram 900 of a communications manager 920 that supports concurrent or overlapping measurement gaps for L1 and L3 measurements in accordance with one or more aspects of the present disclosure. The communications manager 920 may be an example of aspects of a communications manager 720, a communications manager 820, or both, as described herein. The communications manager 920, or various components thereof, may be an example of means for performing various aspects of using concurrent or overlapping measurement gaps for L1 and L3 measurements as described herein. For example, the communications manager 920 may include a capability component 925, a measurement gap component 930, a channel measurement component 935, a report component 940, a selection component 945, a detection component 950, or any combination thereof. Each of these components may communicate, directly or indirectly, with one another (e.g., via one or more buses).

The communications manager 920 may support wireless communication at a UE in accordance with examples as disclosed herein. The capability component 925 may be configured as or otherwise support a means for transmitting a capability message indicating a capability of the UE to support concurrent measurement gaps for L1 channel measurements. The measurement gap component 930 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements. The channel measurement component 935 may be configured as or otherwise support a means for performing at least a portion of the set of channel measurements using the first measurement gap or the second measurement gap in accordance with the capability message. The report component 940 may be configured as or otherwise support a means for transmitting a channel measurement report in accordance with performing at least the portion of the set of channel measurements.

In some examples, to support transmitting the capability message, the capability component 925 may be configured as or otherwise support a means for transmitting, via the capability message, a single UE capability information element indicating that the UE is capable of supporting the concurrent measurement gaps for both the L1 channel measurements and L3 channel measurements.

In some examples, to support transmitting the capability message, the capability component 925 may be configured as or otherwise support a means for transmitting, via the capability message, a first UE capability information element indicating that the UE is capable of supporting the concurrent measurement gaps for the L1 channel measurements, wherein the first UE capability information element is separate from a second UE capability information element indicating whether the UE is capable of supporting the concurrent measurement gaps for L3 channel measurements.

In some examples, the selection component 945 may be configured as or otherwise support a means for selecting one of the first measurement gap or the second measurement gap to apply for at least the portion of the set of channel measurements at the UE according to a scheduling collision between a first measurement gap occasion associated with the first measurement gap and a second measurement gap occasion associated with the second measurement gap.

In some examples, the detection component 950 may be configured as or otherwise support a means for detecting the scheduling collision based on an overlap in time between the first measurement gap occasion and the second measurement gap occasion.

In some examples, the detection component 950 may be configured as or otherwise support a means for detecting the scheduling collision based on a timing between the first measurement gap occasion and the second measurement gap occasion in time being equal to or less than a defined threshold.

In some examples, the timing between the first measurement gap occasion and the second measurement gap occasion is measured between an end of the first measurement gap occasion and a beginning of the second measurement gap occasion, wherein the first measurement gap occasion occurs before the second measurement gap occasion in time. In some examples, the defined threshold is 4 milliseconds.

In some examples, the first measurement gap and the second measurement gap include inter-frequency measurement gaps. In some examples, the first measurement gap is associated with a first CSI report and the second measurement gap is associated with a second CSI report.

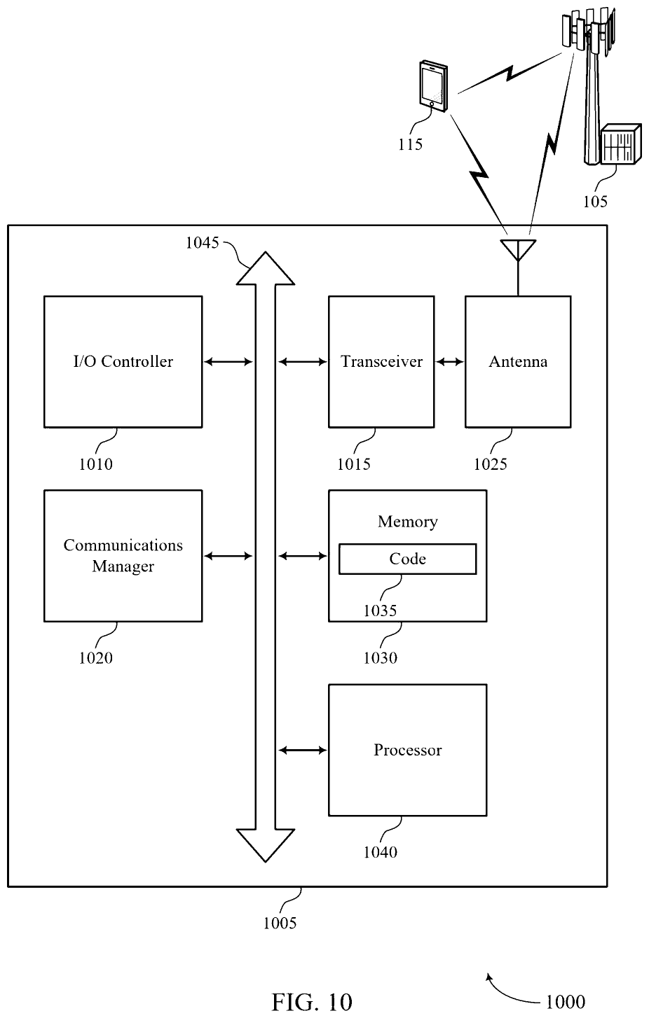

FIG. 10 illustrates a diagram of a system 1000 including a device 1005 that supports concurrent or overlapping measurement gaps for L1 and L3 measurements in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting using concurrent or overlapping measurement gaps for L1 and L3 measurements). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for transmitting a capability message indicating a capability of the UE to support concurrent measurement gaps for L1 channel measurements. The communications manager 1020 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements. The communications manager 1020 may be configured as or otherwise support a means for performing at least a portion of the set of channel measurements using the first measurement gap or the second measurement gap in accordance with the capability message. The communications manager 1020 may be configured as or otherwise support a means for transmitting a channel measurement report in accordance with performing at least the portion of the set of channel measurements.

By including or configuring the communications manager 1020 in accordance with examples as described herein, the device 1005 may support techniques for using concurrent measurement gaps for L1 channel measurements, which may reduce latency and improve UE mobility.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of using concurrent or overlapping measurement gaps for L1 and L3 measurements as described herein, or the processor 1040 and the memory 1030 may be otherwise configured to perform or support such operations.

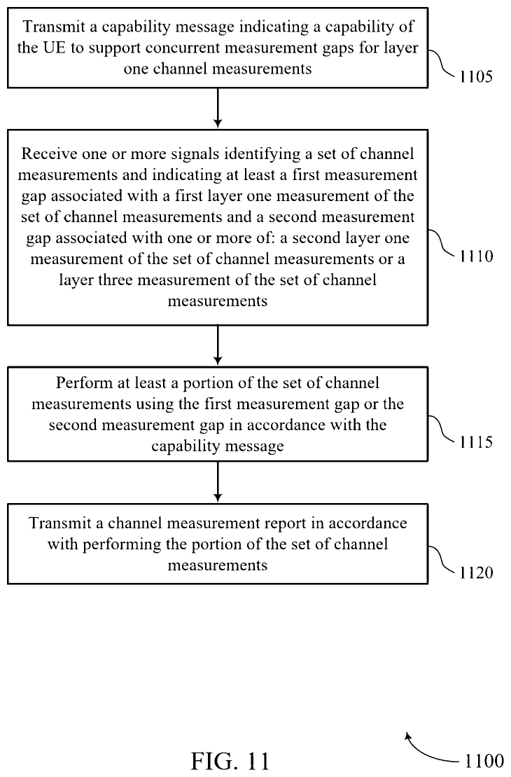

FIG. 11 illustrates a flowchart illustrating a method 1100 that supports concurrent or overlapping measurement gaps for L1 and L3 measurements in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include transmitting a capability message indicating a capability of the UE to support concurrent measurement gaps for L1 channel measurements. The operations of 1105 may be performed in accordance with examples as disclosed herein. In some examples, aspects of the operations of 1105 may be performed by a capability component 925 as described with reference to FIG. 9.

At 1110, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements.

The operations of 1110 may be performed in accordance with examples as disclosed herein. In some examples, aspects of the operations of 1110 may be performed by a measurement gap component 930 as described with reference to FIG. 9.

At 1115, the method may include performing at least a portion of the set of channel measurements using the first measurement gap or the second measurement gap in accordance with the capability message. The operations of 1115 may be performed in accordance with examples as disclosed herein. In some examples, aspects of the operations of 1115 may be performed by a channel measurement component 935 as described with reference to FIG. 9.

At 1120, the method may include transmitting a channel measurement report in accordance with performing at least the portion of the set of channel measurements. The operations of 1120 may be performed in accordance with examples as disclosed herein. In some examples, aspects of the operations of 1120 may be performed by a report component 940 as described with reference to FIG. 9.

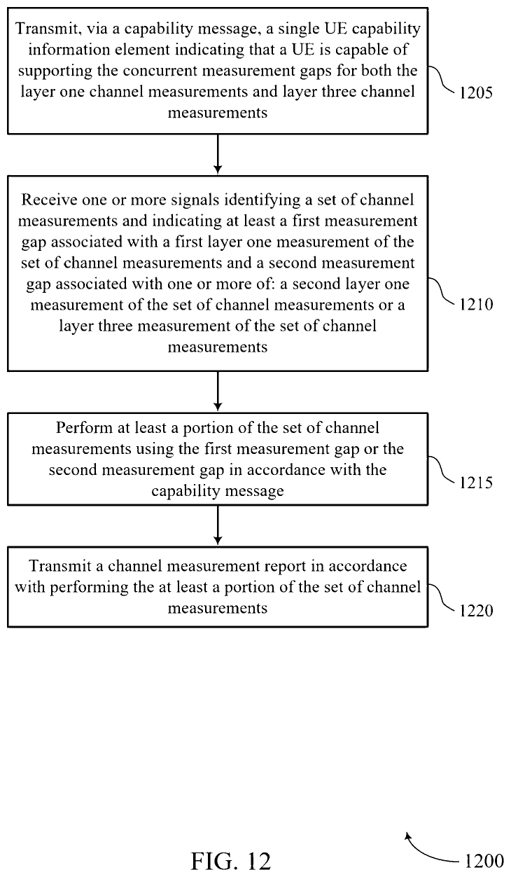

FIG. 12 illustrates a flowchart illustrating a method 1200 that supports concurrent or overlapping measurement gaps for L1 and L3 measurements in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include transmitting, via a capability message, a single UE capability information element indicating that a UE is capable of supporting concurrent measurement gaps for both L1 channel measurements and L3 channel measurements. The operations of 1205 may be performed in accordance with examples as disclosed herein. In some examples, aspects of the operations of 1205 may be performed by a capability component 925 as described with reference to FIG. 9.

At 1210, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements.

The operations of 1210 may be performed in accordance with examples as disclosed herein. In some examples, aspects of the operations of 1210 may be performed by a measurement gap component 930 as described with reference to FIG. 9.

At 1215, the method may include performing at least a portion of the set of channel measurements using the first measurement gap or the second measurement gap in accordance with the capability message. The operations of 1215 may be performed in accordance with examples as disclosed herein. In some examples, aspects of the operations of 1215 may be performed by a channel measurement component 935 as described with reference to FIG. 9.

At 1220, the method may include transmitting a channel measurement report in accordance with performing at least the portion of the set of channel measurements. The operations of 1220 may be performed in accordance with examples as disclosed herein. In some examples, aspects of the operations of 1220 may be performed by a report component 940 as described with reference to FIG. 9.

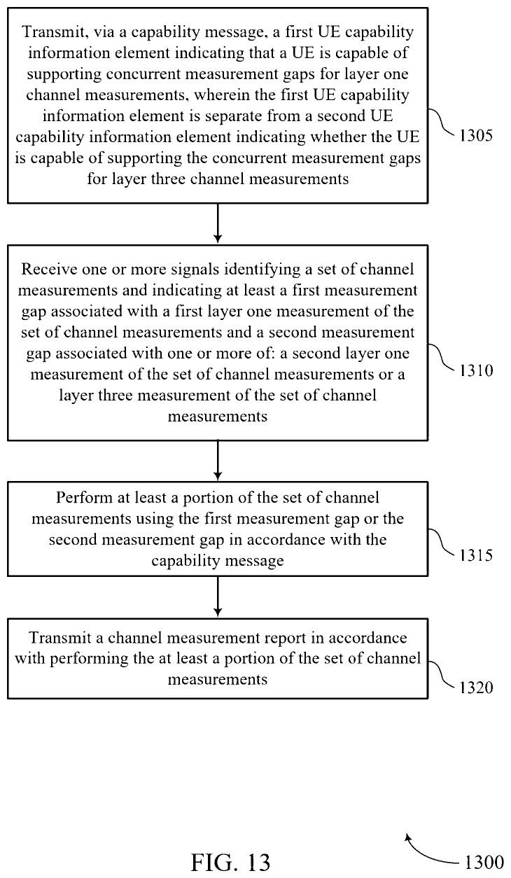

FIG. 13 illustrates a flowchart illustrating a method 1300 that supports concurrent or overlapping measurement gaps for L1 and L3 measurements in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include transmitting, via a capability message, a first UE capability information element indicating that a UE is capable of supporting concurrent measurement gaps for L1 channel measurements, wherein the first UE capability information element is separate from a second UE capability information element indicating whether the UE is capable of supporting the concurrent measurement gaps for L3 channel measurements. The operations of 1305 may be performed in accordance with examples as disclosed herein. In some examples, aspects of the operations of 1305 may be performed by a capability component 925 as described with reference to FIG. 9.

At 1310, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements.

The operations of 1310 may be performed in accordance with examples as disclosed herein. In some examples, aspects of the operations of 1310 may be performed by a measurement gap component 930 as described with reference to FIG. 9.

At 1315, the method may include performing at least a portion of the set of channel measurements using the first measurement gap or the second measurement gap in accordance with the capability message. The operations of 1315 may be performed in accordance with examples as disclosed herein. In some examples, aspects of the operations of 1315 may be performed by a channel measurement component 935 as described with reference to FIG. 9.

At 1320, the method may include transmitting a channel measurement report in accordance with performing at least the portion of the set of channel measurements. The operations of 1320 may be performed in accordance with examples as disclosed herein. In some examples, aspects of the operations of 1320 may be performed by a report component 940 as described with reference to FIG. 9.

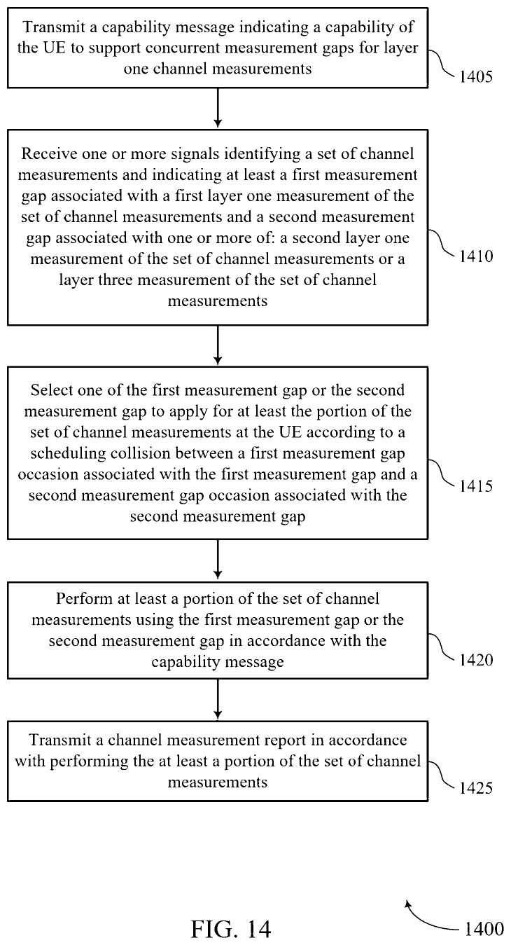

FIG. 14 illustrates a flowchart illustrating a method 1400 that supports concurrent or overlapping measurement gaps for L1 and L3 measurements in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a capability of the UE to support concurrent measurement gaps for L1 channel measurements. The operations of 1405 may be performed in accordance with examples as disclosed herein. In some examples, aspects of the operations of 1405 may be performed by a capability component 925 as described with reference to FIG. 9.

At 1410, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements.

The operations of 1410 may be performed in accordance with examples as disclosed herein. In some examples, aspects of the operations of 1410 may be performed by a measurement gap component 930 as described with reference to FIG. 9.

At 1415, the method may include selecting one of the first measurement gap or the second measurement gap to apply for at least the portion of the set of channel measurements at the UE according to a scheduling collision between a first measurement gap occasion associated with the first measurement gap and a second measurement gap occasion associated with the second measurement gap. The operations of 1415 may be performed in accordance with examples as disclosed herein. In some examples, aspects of the operations of 1415 may be performed by a selection component 945 as described with reference to FIG. 9.

At 1420, the method may include performing at least a portion of the set of channel measurements using the first measurement gap or the second measurement gap in accordance with the capability message. The operations of 1420 may be performed in accordance with examples as disclosed herein. In some examples, aspects of the operations of 1420 may be performed by a channel measurement component 935 as described with reference to FIG. 9.

At 1425, the method may include transmitting a channel measurement report in accordance with performing at least the portion of the set of channel measurements. The operations of 1425 may be performed in accordance with examples as disclosed herein. In some examples, aspects of the operations of 1425 may be performed by a report component 940 as described with reference to FIG. 9.

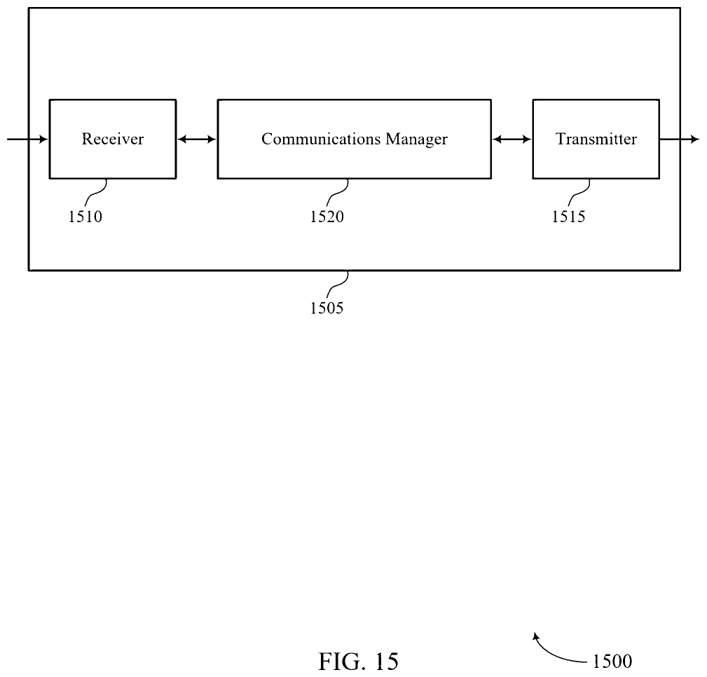

FIG. 15 illustrates a block diagram 1500 of a device 1505 that supports concurrent or overlapping measurement gaps for L1 and L3 3 measurements in accordance with one or more aspects of the present disclosure. The device 1505 may be an example of aspects of a UE 115 as described herein. The device 1505 may include a receiver 1510, a transmitter 1515, and a communications manager 1520. The device 1505 may also include a processor. Each of these components may be in communication with one another (e.g., via one or more buses). Components within a wireless communication system may be coupled (for example, operatively, communicatively, functionally, electronically, and/or electrically) to each other.

The receiver 1510 may provide a means for receiving information such as packets, user data, control information, or any combination thereof associated with various information channels (e.g., control channels, data channels, information channels related to concurrent or overlapping measurement gaps for L1 and L3 measurements). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to concurrent or overlapping measurement gaps for L1 and L3 measurements). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of concurrent or overlapping measurement gaps for L1 and L3 measurements as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware, software (e.g., executed by a processor), or any combination thereof. The hardware may include a processor, a DSP, a CPU, a GPU, an ASIC, an FPGA, or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software) executed by a processor. If implemented in code executed by a processor, the functions of the communications manager 1520, the receiver 1510, the transmitter 1515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a UE in accordance with examples as disclosed herein. For example, the communications manager 1520 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The communications manager 1520 may be configured as or otherwise support a means for selecting one of the first measurement gap or the second measurement gap to apply for the set of channel measurements at the UE according to a prioritization between the first measurement gap and the second measurement gap and an overlap in time between the first measurement gap and the second measurement gap. The communications manager 1520 may be configured as or otherwise support a means for performing at least a portion of the set of channel measurements and using the first measurement gap or the second measurement gap according to the selecting.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for selecting between overlapping L1 and L1 or L3 channel measurements based on a prioritization rule associated with each measurement gap.

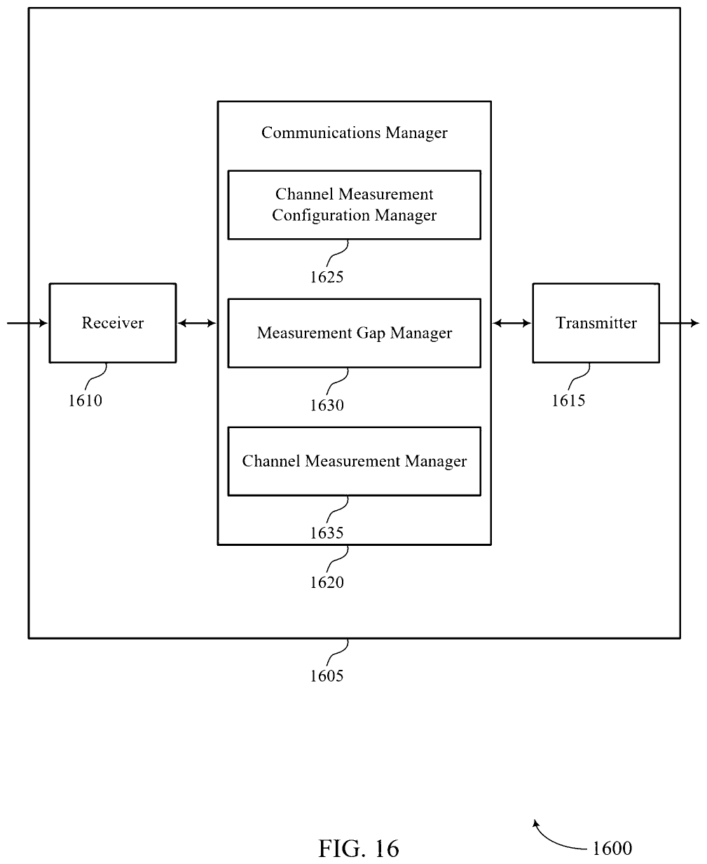

FIG. 16 illustrates a block diagram 1600 of a device 1605 that supports concurrent or overlapping measurement gaps for L1 and L3 measurements in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to concurrent or overlapping measurement gaps for L1 and L3 measurements). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to concurrent or overlapping measurement gaps for L1 and L3 measurements). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of concurrent or overlapping measurement gaps for L1 and L3 measurements as described herein. For example, the communications manager 1620 may include a channel measurement configuration manager 1625, a measurement gap manager 1630, a channel measurement manager 1635, or any combination thereof. The communications manager 1620 may be an example of aspects of a communications manager 720 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a UE in accordance with examples as disclosed herein. The channel measurement configuration manager 1625 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The measurement gap manager 1630 may be configured as or otherwise support a means for selecting one of the first measurement gap or the second measurement gap to apply for the set of channel measurements at the UE according to a prioritization between the first measurement gap and the second measurement gap and an overlap in time between the first measurement gap and the second measurement gap. The channel measurement manager 1635 may be configured as or otherwise support a means for performing at least a portion of the set of channel measurements and using the first measurement gap or the second measurement gap according to the selecting.

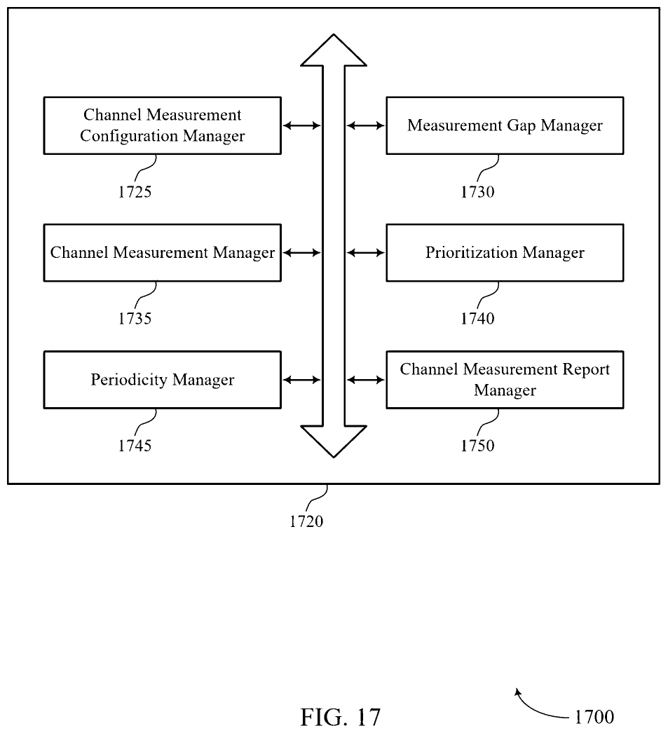

FIG. 17 illustrates a block diagram 1700 of a communications manager 1720 that supports concurrent or overlapping measurement gaps for L1 and L3 measurements in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of concurrent or overlapping measurement gaps for L1 and L3 measurements as described herein. For example, the communications manager 1720 may include a channel measurement configuration manager 1725, a measurement gap manager 1730, a channel measurement manager 1735, a prioritization manager 1740, a periodicity manager 1745, a channel measurement report manager 1750, or any combination thereof. Each of these components may communicate, directly or indirectly, with one another (e.g., via one or more buses).

The communications manager 1720 may support wireless communications at a UE in accordance with examples as disclosed herein. The channel measurement configuration manager 1725 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The measurement gap manager 1730 may be configured as or otherwise support a means for selecting one of the first measurement gap or the second measurement gap to apply for the set of channel measurements at the UE according to a prioritization between the first measurement gap and the second measurement gap and an overlap in time between the first measurement gap and the second measurement gap. The channel measurement manager 1735 may be configured as or otherwise support a means for performing at least a portion of the set of channel measurements and using the first measurement gap or the second measurement gap according to the selecting.

In some examples, to support selecting the one of the first measurement gap or the second measurement gap, the prioritization manager 1740 may be configured as or otherwise support a means for prioritizing between the first measurement gap and the second measurement gap according to a difference between a first priority level associated with the first measurement gap and a second priority level associated with the second measurement gap.

In some examples, to support selecting the one of the first measurement gap or the second measurement gap, the periodicity manager 1745 may be configured as or otherwise support a means for prioritizing between the first measurement gap and the second measurement gap according to a difference between a first periodicity associated with the first measurement gap and a second periodicity associated with the second measurement gap.

In some examples, to support selecting the one of the first measurement gap or the second measurement gap, the prioritization manager 1740 may be configured as or otherwise support a means for prioritizing between the first measurement gap and the second measurement gap according to a difference between a first priority level associated with L1 measurements and a second priority level associated with L3 measurements. In some examples, the second priority level includes a higher priority level than the first priority level.

In some examples, to support selecting the one of the first measurement gap or the second measurement gap, the prioritization manager 1740 may be configured as or otherwise support a means for prioritizing between the first measurement gap and the second measurement gap according to a difference between a first priority level associated with traffic to be communicated based on a result of the first L1 measurement and a second priority level associated with traffic to be communicated based on a result of the one or more of the second L1 measurement or the L3 measurement.

In some examples, to support selecting the one of the first measurement gap or the second measurement gap, the prioritization manager 1740 may be configured as or otherwise support a means for prioritizing between the first measurement gap and the second measurement gap according to a difference between a first priority level associated with a first channel state information report to be communicated based on a result of the first L1 measurement and a second priority level associated with a second channel state information report to be communicated based on a result of one or more of the second L1 measurement or the L3 measurement.

In some examples, the prioritization manager 1740 may be configured as or otherwise support a means for determining a first identifier associated with the first channel state information report and a second identifier associated with the second channel state information report, where the first priority level is based on the first identifier and the second priority level is based on the second identifier.

In some examples, to support selecting the one of the first measurement gap or the second measurement gap, the periodicity manager 1745 may be configured as or otherwise support a means for prioritizing between the first measurement gap and the second measurement gap according to a difference between a first periodicity of a first channel state information report to be communicated based on a result of the first L1 measurement and a second periodicity of a second channel state information report to be communicated based on a result of one or more of the second L1 measurement or the L3 measurement.

In some examples, the channel measurement report manager 1750 may be configured as or otherwise support a means for transmitting a channel measurement report in accordance with performing at least the portion of the set of channel measurements using the first measurement gap or the second measurement gap. In some examples, the first measurement gap and the second measurement gap include inter-frequency measurement gaps. In some examples, the first measurement gap is associated with a first channel state information report and the second measurement gap is associated with a second channel state information report.

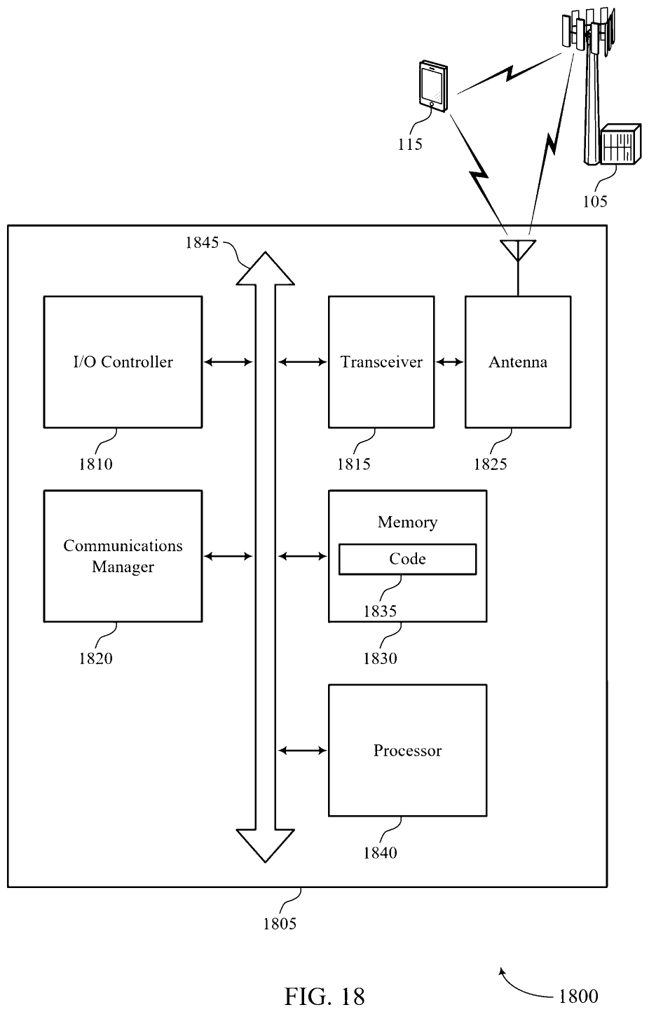

FIG. 18 illustrates a diagram of a system 1800 including a device 1805 that supports concurrent or overlapping measurement gaps for L1 and L3 measurements in accordance with one or more aspects of the present disclosure. The device 1805 may be an example of or include the components of a device 1505, a device 1605, or a UE 115 as described herein. The device 1805 may communicate (e.g., wirelessly) with one or more network entities 105, one or more UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, a memory 1830, code 1835, and a processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®,UNIX®, LINUX®, or another known operating system. Additionally or alternatively, the I/O controller 1810 may represent or interact with a modem, a keyboard, a mouse, a touchscreen, or a similar device. In some cases, the I/O controller 1810 may be implemented as part of a processor, such as the processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions.

The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 715, a transmitter 815, a receiver 710, a receiver 810, or any combination thereof or component thereof, as described herein.

The memory 1830 may include random access memory (RAM) and read-only memory (ROM). The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a basic I/O system (BIOS) which may control basic hardware or software operation such as the interaction with peripheral components or devices.

The processor 1840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting concurrent or overlapping measurement gaps for L1 and L3 measurements). For example, the device 1805 or a component of the device 1805 may include a processor 1840 and memory 1830 coupled with or to the processor 1840, the processor 1840 and memory 1830 configured to perform various functions described herein.

The communications manager 1820 may support wireless communications at a UE in accordance with examples as disclosed herein. For example, the communications manager 1820 may be configured as or otherwise support a means for receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The communications manager 1820 may be configured as or otherwise support a means for selecting one of the first measurement gap or the second measurement gap to apply for the set of channel measurements at the UE according to a prioritization between the first measurement gap and the second measurement gap and an overlap in time between the first measurement gap and the second measurement gap. The communications manager 1820 may be configured as or otherwise support a means for performing at least a portion of the set of channel measurements and using the first measurement gap or the second measurement gap according to the selecting.

By including or configuring the communications manager 1820 in accordance with examples as described herein, the device 1805 may support techniques for selecting between overlapping L1 and L1 or L3 channel measurements based on a prioritization rule associated with each measurement gap.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of concurrent or overlapping measurement gaps for L1 and L3 measurements as described herein, or the processor 1840 and the memory 1830 may be otherwise configured to perform or support such operations.

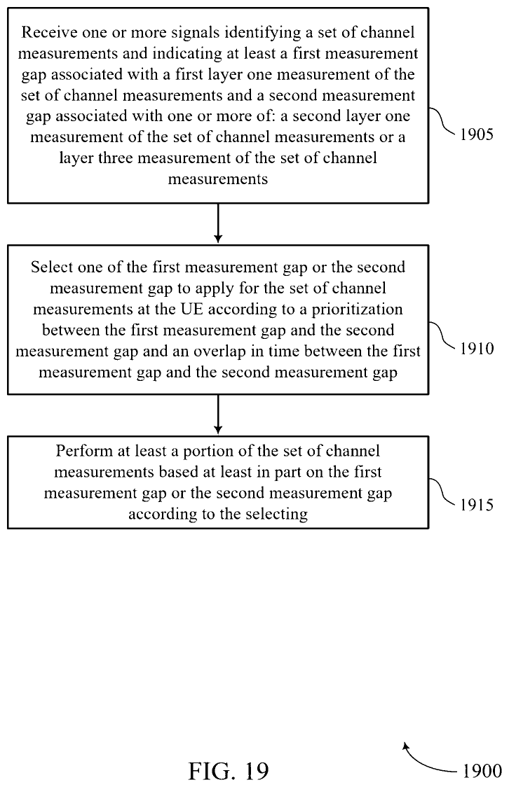

FIG. 19 illustrates a flowchart illustrating a method 1900 that supports concurrent or overlapping measurement gaps for L1 and L3 measurements in accordance with one or more aspects of the present disclosure. The operations of the method 1900 may be implemented by a UE or its components as described herein. For example, the operations of the method 1900 may be performed by a UE 115 as described with reference to FIGS. 1 through 6 and 15 through 18. In some examples, a UE may execute a set of instructions to control the functional elements of the UE to perform the described functions. Additionally, or alternatively, the UE may perform aspects of the described functions using special-purpose hardware.

At 1905, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The operations of 1905 may be performed in accordance with examples as disclosed herein. In some examples, aspects of the operations of 1905 may be performed by a channel measurement configuration manager 1725 as described with reference to FIG. 17.

At 1910, the method may include selecting one of the first measurement gap or the second measurement gap to apply for the set of channel measurements at the UE according to a prioritization between the first measurement gap and the second measurement gap and an overlap in time between the first measurement gap and the second measurement gap. The operations of 1910 may be performed in accordance with examples as disclosed herein. In some examples, aspects of the operations of 1910 may be performed by a measurement gap manager 1730 as described with reference to FIG. 17.

At 1915, the method may include performing at least a portion of the set of channel measurements and using the first measurement gap or the second measurement gap according to the selecting. The operations of 1915 may be performed in accordance with examples as disclosed herein. In some examples, aspects of the operations of 1915 may be performed by a channel measurement manager 1735 as described with reference to FIG. 17.

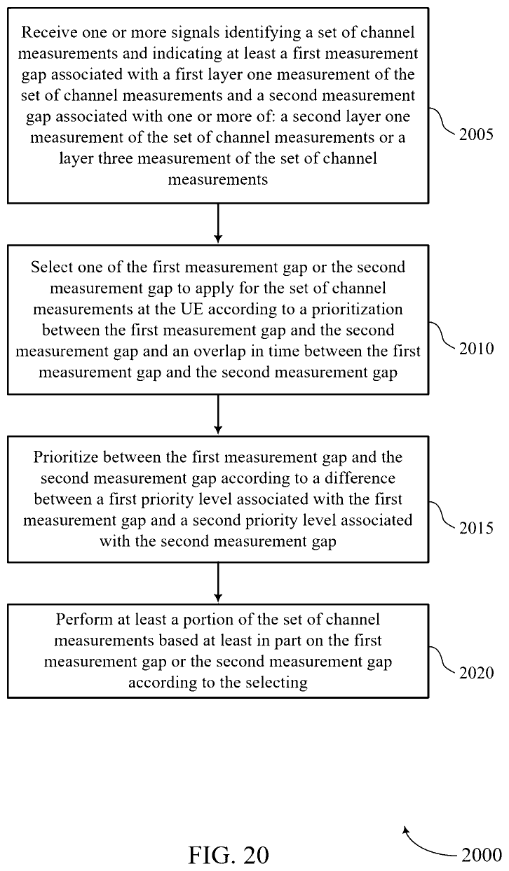

FIG. 20 illustrates a flowchart illustrating a method 2000 that supports concurrent or overlapping measurement gaps for L1 and L3 measurements in accordance with one or more aspects of the present disclosure. The operations of the method 2000 may be implemented by a UE or its components as described herein. For example, the operations of the method 2000 may be performed by a UE 115 as described with reference to FIGS. 1 through 6 and 15 through 18. In some examples, a UE may execute a set of instructions to control the functional elements of the UE to perform the described functions. Additionally, or alternatively, the UE may perform aspects of the described functions using special-purpose hardware.

At 2005, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The operations of 2005 may be performed in accordance with examples as disclosed herein. In some examples, aspects of the operations of 2005 may be performed by a channel measurement configuration manager 1725 as described with reference to FIG. 17.

At 2010, the method may include selecting one of the first measurement gap or the second measurement gap to apply for the set of channel measurements at the UE according to a prioritization between the first measurement gap and the second measurement gap and an overlap in time between the first measurement gap and the second measurement gap. The operations of 2010 may be performed in accordance with examples as disclosed herein. In some examples, aspects of the operations of 2010 may be performed by a measurement gap manager 1730 as described with reference to FIG. 17.

At 2015, the method may include prioritizing between the first measurement gap and the second measurement gap according to a difference between a first priority level associated with the first measurement gap and a second priority level associated with the second measurement gap. The operations of 2015 may be performed in accordance with examples as disclosed herein. In some examples, aspects of the operations of 2015 may be performed by a prioritization manager 1740 as described with reference to FIG. 17.

At 2020, the method may include performing at least a portion of the set of channel measurements and using the first measurement gap or the second measurement gap according to the selecting. The operations of 2020 may be performed in accordance with examples as disclosed herein. In some examples, aspects of the operations of 2020 may be performed by a channel measurement manager 1735 as described with reference to FIG. 17.

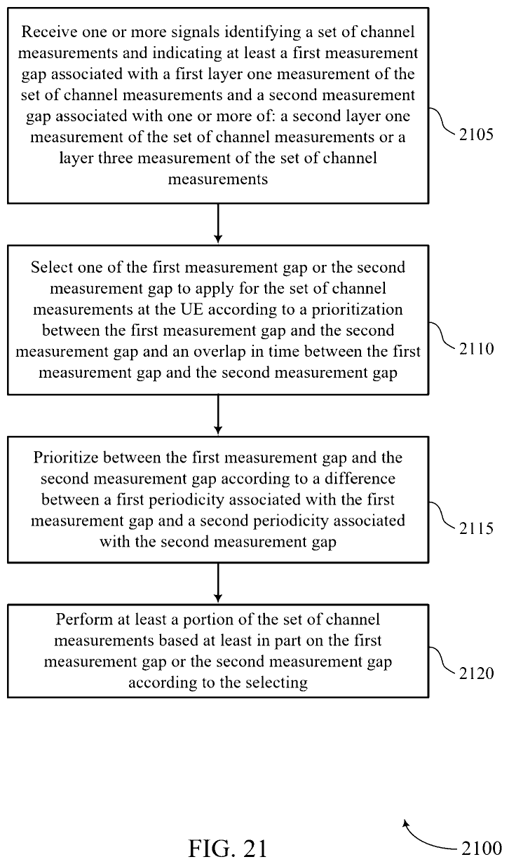

FIG. 21 illustrates a flowchart illustrating a method 2100 that supports concurrent or overlapping measurement gaps for L1 and L3 measurements in accordance with one or more aspects of the present disclosure. The operations of the method 2100 may be implemented by a UE or its components as described herein. For example, the operations of the method 2100 may be performed by a UE 115 as described with reference to FIGS. 1 through 6 and 15 through 18. In some examples, a UE may execute a set of instructions to control the functional elements of the UE to perform the described functions. Additionally, or alternatively, the UE may perform aspects of the described functions using special-purpose hardware.

At 2105, the method may include receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements. The operations of 2105 may be performed in accordance with examples as disclosed herein. In some examples, aspects of the operations of 2105 may be performed by a channel measurement configuration manager 1725 as described with reference to FIG. 17.

At 2110, the method may include selecting one of the first measurement gap or the second measurement gap to apply for the set of channel measurements at the UE according to a prioritization between the first measurement gap and the second measurement gap and an overlap in time between the first measurement gap and the second measurement gap. The operations of 2110 may be performed in accordance with examples as disclosed herein. In some examples, aspects of the operations of 2110 may be performed by a measurement gap manager 1730 as described with reference to FIG. 17.

At 2115, the method may include prioritizing between the first measurement gap and the second measurement gap according to a difference between a first periodicity associated with the first measurement gap and a second periodicity associated with the second measurement gap. The operations of 2115 may be performed in accordance with examples as disclosed herein. In some examples, aspects of the operations of 2115 may be performed by a periodicity manager 1745 as described with reference to FIG. 17.

At 2120, the method may include performing at least a portion of the set of channel measurements and based at least in part on the first measurement gap or the second measurement gap according to the selecting. The operations of 2120 may be performed in accordance with examples as disclosed herein. In some examples, aspects of the operations of 2120 may be performed by a channel measurement manager 1735 as described with reference to FIG. 17.

The following provides an overview of aspects of the present disclosure:

Aspect 1: A method for wireless communication at a UE, comprising: transmitting a capability message indicating a capability of the UE to support concurrent measurement gaps for L1 channel measurements; receiving one or more signals identifying a set of channel measurements and indicating at least a first measurement gap associated with a first L1 measurement of the set of channel measurements and a second measurement gap associated with one or more of: a second L1 measurement of the set of channel measurements or an L3 measurement of the set of channel measurements; performing at least a portion of the set of channel measurements using the first measurement gap or the second measurement gap in accordance with the capability message; and transmitting a channel measurement report in accordance with performing at least the portion of the set of channel measurements.

Aspect 2: The method of aspect 1, wherein transmitting the capability message comprises: transmitting, via the capability message, a single UE capability information element indicating that the UE is capable of supporting the concurrent measurement gaps for both the L1 channel measurements and L3 channel measurements.

Aspect 3: The method of any of aspects 1 through 2, wherein transmitting the capability message comprises: transmitting, via the capability message, a first UE capability information element indicating that the UE is capable of supporting the concurrent measurement gaps for the L1 channel measurements, wherein the first UE capability information element is separate from a second UE capability information element indicating whether the UE is capable of supporting the concurrent measurement gaps for L3 channel measurements.

Aspect 4: The method of any of aspects 1 through 3, further comprising: selecting one of the first measurement gap or the second measurement gap to apply for at least the portion of the set of channel measurements at the UE according to a scheduling collision between a first measurement gap occasion associated with the first measurement gap and a second measurement gap occasion associated with the second measurement gap.

Aspect 5: The method of aspect 4, further comprising: detecting the scheduling collision based at least in part on an overlap in time between the first measurement gap occasion and the second measurement gap occasion.

Aspect 6: The method of any of aspects 4 through 5, further comprising: detecting the scheduling collision based at least in part on a timing between the first measurement gap occasion and the second measurement gap occasion in time being equal to or less than a defined threshold.

Aspect 7: The method of aspect 6, wherein the timing between the first measurement gap occasion and the second measurement gap occasion is measured between an end of the first measurement gap occasion and a beginning of the second measurement gap occasion, wherein the first measurement gap occasion occurs before the second measurement gap occasion in time.

Aspect 8: The method of any of aspects 6 through 7, wherein the defined threshold is 4 milliseconds.

Aspect 9: The method of any of aspects 1 through 8, wherein the first measurement gap and the second measurement gap comprise inter-frequency measurement gaps.

Aspect 10: The method of any of aspects 1 through 9, wherein the first measurement gap is associated with a first CSI report and the second measurement gap is associated with a second CSI report.

Aspect 11: A UE, comprising one or more memories storing processor-executable code; and one or more processors coupled (e.g., operatively, communicatively, functionally, electronically, or electrically) with the one or more memories and individually or collectively operable (e.g., directly, indirectly, after pre-processing, without pre-processing) to execute the code to cause the UE to perform a method of any of aspects 1 through 10.

Aspect 12: A UE, comprising at least one means for performing a method of any of aspects 1 through 10.

Aspect 13: A non-transitory computer-readable medium storing code for wireless communication, the code comprising instructions executable by one or more processors (e.g., directly, indirectly, after pre-processing, without pre-processing) to perform a method of any of aspects 1 through 10.

Aspect 14: A method for wireless communications at a UE, comprising: receiving one or more signals identifying a set of channel measurements and indicating at least a first measurement gap associated with a first L1 measurement of the set of channel measurements and a second measurement gap associated with one or more of: a second L1 measurement of the set of channel measurements or a L3 measurement of the set of channel measurements; selecting one of the first measurement gap or the second measurement gap to apply for the set of channel measurements at the UE according to a prioritization between the first measurement gap and the second measurement gap and an overlap in time between the first measurement gap and the second measurement gap; and performing at least a portion of the set of channel measurements and using the first measurement gap or the second measurement gap according to the selecting.

Aspect 15: The method of aspect 14, wherein selecting the one of the first measurement gap or the second measurement gap comprises: prioritizing between the first measurement gap and the second measurement gap according to a difference between a first priority level associated with the first measurement gap and a second priority level associated with the second measurement gap.

Aspect 16: The method of any of aspects 14 through 15, wherein selecting the one of the first measurement gap or the second measurement gap comprises: prioritizing between the first measurement gap and the second measurement gap according to a difference between a first periodicity associated with the first measurement gap and a second periodicity associated with the second measurement gap.

Aspect 17: The method of any of aspects 14 through 16, wherein selecting the one of the first measurement gap or the second measurement gap comprises: prioritizing between the first measurement gap and the second measurement gap according to a difference between a first priority level associated with L1 measurements and a second priority level associated with L3 measurements.

Aspect 18: The method of aspect 17, wherein the second priority level comprises a higher priority level than the first priority level.

Aspect 19: The method of any of aspects 14 through 18, wherein selecting the one of the first measurement gap or the second measurement gap comprises: prioritizing between the first measurement gap and the second measurement gap according to a difference between a first priority level associated with traffic to be communicated based on a result of the first L1 measurement and a second priority level associated with traffic to be communicated based on a result of the one or more of the second L1 measurement or the L3 measurement.

Aspect 20: The method of any of aspects 14 through 19, wherein selecting the one of the first measurement gap or the second measurement gap comprises: prioritizing between the first measurement gap and the second measurement gap according to a difference between a first priority level associated with a first CSI report to be communicated based on a result of the first L1 measurement and a second priority level associated with a second CSI report to be communicated based on a result of one or more of the second L1 measurement or the L3 measurement.

Aspect 21: The method of aspect 20, further comprising: determining a first identifier associated with the first CSI report and a second identifier associated with the second CSI report, wherein the first priority level is based on the first identifier and the second priority level is based on the second identifier.

Aspect 22: The method of any of aspects 14 through 21, wherein selecting the one of the first measurement gap or the second measurement gap comprises: prioritizing between the first measurement gap and the second measurement gap according to a difference between a first periodicity of a first CSI report to be communicated based on a result of the first L1 measurement and a second periodicity of a second CSI report to be communicated based on a result of one or more of the second L1 measurement or the L3 measurement.

Aspect 23: The method of any of aspects 14 through 22, further comprising: transmitting a channel measurement report in accordance with performing at least the portion of the set of channel measurements using the first measurement gap or the second measurement gap.

Aspect 24: The method of any of aspects 16 through 23, wherein the first measurement gap and the second measurement gap comprise inter-frequency measurement gaps.

Aspect 25: The method of any of aspects 16 through 24, wherein the first measurement gap is associated with a first CSI report and the second measurement gap is associated with a second CSI report.

Aspect 26: A UE, comprising one or more memories storing processor-executable code; and one or more processors coupled (e.g., operatively, communicatively, functionally, electronically, or electrically) with the one or more memories and individually or collectively operable (e.g., directly, indirectly, after pre-processing, without pre-processing) to execute the code to cause the UE to perform a method of any of aspects 16 through 25.

Aspect 27: A UE, comprising at least one means for performing a method of any of aspects 16 through 25.

Aspect 28: A non-transitory computer-readable medium storing code for communications, the code comprising instructions executable by one or more processors (e.g., directly, indirectly, after pre-processing, without pre-processing) to perform a method of any of aspects 16 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), IEEE 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein. Please enter the following amendments to the claims:

1. A user equipment (UE), comprising:
one or more memories storing processor-executable code; and
one or more processors coupled with the one or more memories and individually or collectively operable to execute the code to cause the UE to:
transmit a capability message indicating a capability of the UE to support concurrent measurement gaps for layer one (L1) channel measurements;
receive one or more signals identifying a set of channel measurements and indicating at least a first measurement gap associated with a first L1 measurement of the set of channel measurements and a second measurement gap associated with one or more of: a second L1 measurement of the set of channel measurements or a layer three measurement of the set of channel measurements;
perform at least a portion of the set of channel measurements using the first measurement gap or the second measurement gap in accordance with the capability message; and
transmit a channel measurement report in accordance with performing at least the portion of the set of channel measurements.

2. The UE of claim 1, wherein, to transmit the capability message, the one or more processors are individually or collectively operatable to execute the code to cause the UE to:
transmit, via the capability message, a single UE capability information element indicating that the UE is capable of supporting the concurrent measurement gaps for both the L1 channel measurements and layer three channel measurements.

3. The UE of claim 1, wherein, to transmit the capability message, the one or more processors are individually or collectively operatable to execute the code to cause the UE to:
transmit, via the capability message, a first UE capability information element indicating that the UE is capable of supporting the concurrent measurement gaps for the L1 channel measurements, wherein the first UE capability information element is separate from a second UE capability information element indicating whether the UE is capable of supporting the concurrent measurement gaps for layer three channel measurements.

4. The UE of claim 1, wherein the one or more processors are individually or collectively further operatable to execute the code to cause the UE to:
select one of the first measurement gap or the second measurement gap to apply for at least the portion of the set of channel measurements at the UE according to a scheduling collision between a first measurement gap occasion associated with the first measurement gap and a second measurement gap occasion associated with the second measurement gap.

5. The UE of claim 4, wherein the one or more processors are individually or collectively further operatable to execute the code to cause the UE to:
detect the scheduling collision based at least in part on an overlap in time between the first measurement gap occasion and the second measurement gap occasion.

6. The UE of claim 4, wherein the one or more processors are individually or collectively further operatable to execute the code to cause the UE to:
detect the scheduling collision based at least in part on a timing between the first measurement gap occasion and the second measurement gap occasion in time being equal to or less than a defined threshold.

7. The UE of claim 6, wherein the timing between the first measurement gap occasion and the second measurement gap occasion is measured between an end of the first measurement gap occasion and a beginning of the second measurement gap occasion, wherein the first measurement gap occasion occurs before the second measurement gap occasion in time.

8. (canceled)

9. The UE of claim 1, wherein the first measurement gap and the second measurement gap comprise inter-frequency measurement gaps.

10. The UE of claim 1, wherein the first measurement gap is associated with a first channel state information report and the second measurement gap is associated with a second channel state information report.

11. A user equipment (UE), comprising:
one or more memories storing processor-executable code; and
one or more processors coupled with the one or more memories and individually or collectively operable to execute the code:
receive one or more signals identifying a set of channel measurements and indicating at least a first measurement gap associated with a first layer one measurement of the set of channel measurements and a second measurement gap associated with one or more of: a second layer one measurement of the set of channel measurements or a layer three measurement of the set of channel measurements;
select one of the first measurement gap or the second measurement gap to apply for the set of channel measurements at the UE according to a prioritization between the first measurement gap and the second measurement gap and an overlap in time between the first measurement gap and the second measurement gap; and
perform at least a portion of the set of channel measurements and based on the first measurement gap or the second measurement gap according to the selecting.

12. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first priority level associated with the first measurement gap and a second priority level associated with the second measurement gap.

13. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first periodicity associated with the first measurement gap and a second periodicity associated with the second measurement gap.

14. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first priority level associated with layer one measurements and a second priority level associated with layer three measurements.

15. The UE of claim 14, wherein the second priority level comprises a higher priority level than the first priority level.

16. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first priority level associated with traffic to be communicated based on a result of the first layer one measurement and a second priority level associated with traffic to be communicated based on a result of the one or more of the second layer one measurement or the layer three measurement.

17. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first priority level associated with a first channel state information report to be communicated based on a result of the first layer one measurement and a second priority level associated with a second channel state information report to be communicated based on a result of one or more of the second layer one measurement or the layer three measurement.

18. The UE of claim 17, wherein the one or more processors are individually or collectively further operatable to execute the code to cause the UE to:
determine a first identifier associated with the first channel state information report and a second identifier associated with the second channel state information report, wherein the first priority level is based on the first identifier and the second priority level is based on the second identifier.

19. The UE of claim 11, wherein, to select the one of the first measurement gap or the second measurement gap, the one or more processors are individually or collectively operatable to execute the code to cause the UE to:
prioritize between the first measurement gap and the second measurement gap according to a difference between a first periodicity of a first channel state information report to be communicated based on a result of the first layer one measurement and a second periodicity of a second channel state information report to be communicated based on a result of one or more of the second layer one measurement or the layer three measurement.

20. The UE of claim 11, wherein the one or more processors are individually or collectively further operatable to execute the code to cause the UE to:
transmit a channel measurement report in accordance with performing at least the portion of the set of channel measurements using the first measurement gap or the second measurement gap.

21. (canceled)

22. (canceled)

23. A method for wireless communication at a user equipment (UE), comprising:
transmitting a capability message indicating a capability of the UE to support concurrent measurement gaps for layer one (L1) channel measurements;
receiving one or more signals identifying a set of channel measurements and indicating at least a first measurement gap associated with a first L1 measurement of the set of channel measurements and a second measurement gap associated with one or more of: a second L1 measurement of the set of channel measurements or a layer three measurement of the set of channel measurements;
performing at least a portion of the set of channel measurements using the first measurement gap or the second measurement gap in accordance with the capability message; and
transmitting a channel measurement report in accordance with performing at least the portion of the set of channel measurements.

24. (canceled)

25. (canceled)

26. (canceled)

27. (canceled)

28. (canceled)

29. (canceled)

30. (canceled)
